(19) United States
(12) Patent Application Publication
(10) Pub. No.: US 2024/0422818 A1
(43) Pub. Date: Dec. 19, 2024

(54) COMMUNICATION DEVICES AND METHODS FOR BIDIRECTIONAL TRANSMIT OPPORTUNITIES

(71) Applicant: Sony Group Corporation, Tokyo (JP)

(72) Inventors: Ephraim FUCHS, Stuttgart (DE); Thomas HANDTE, Stuttgart (DE); Daniel VERENZUELA, Stuttgart (DE); Dana CIOCHINA-KAR, Stuttgart (DE)

(73) Assignee: Sony Group Corporation, Tokyo (JP)

(21) Appl. No.: 18/701,378

(22) PCT Filed: Oct. 11, 2022
(86) PCT No.: PCT/EP2022/078260

§ 371 Date: Apr. 15, 2024

(30) Foreign Application Priority Data
Oct. 22, 2021 (EP) 21204149.5

(51) Int. Cl. H04W 74/0808

(52) U.S. Cl. CPC H04W 74/0808

(57) ABSTRACT

A first communication device that is configured to bidirectionally exchange data with a second communication device comprises circuitry that is configured to initiate a bidirectional transmit opportunity (TXOP) by transmitting, to the second communication device, a TXOP indicator indicating that a wideband TXOP is split into two channels and indicating that a first channel is primarily to be used for transmission of data from the first communication device to the second communication device and a second channel is primarily to be used for transmission of data from the second communication device to the first communication device. Further, the first communication device transmits data to the second communication device on the first channel and listen for the reception of data from the second communication device on the second channel.

### BACKGROUND

### Field of the Disclosure

The present disclosure relates to first and second communication devices and methods.

### Description of Related Art

In WLAN a transmit opportunity (TXOP) initiator (herein also called “first communication device”) initiates a TXOP by transmitting a frame to a peer station (STA) (TXOP responder, herein also called “second communication device”). The transmission of a frame is often subject to a carrier clear assessment (CCA), i.e., the channel is detected as idle during a random waiting time that depends to the priority of the data to be transmitted and the number of previously failed channel accesses. The TXOP responder responds to the transmitted frame. In such a TXOP, the TXOP initiator may transmit data units to the TXOP responder, whereas the TXOP responder may only transmit response frames, such as Acknowledgements (Ack) or block acknowledgements (BAck). The TXOP responder may not transmit data units to the TXOP initiator unless the TXOP responder starts a separate TXOP, i.e., it gets a TXOP initiator.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present disclosure.

### SUMMARY

It is an object to provide communication devices and methods that are able to initiate and operate a bidirectional TXOP. It is a further object to provide a corresponding computer program and a non-transitory computer-readable recording medium for implementing the communication methods.

According to an aspect there is provided a first communication device configured to bidirectionally exchange data with a second communication device, the first communication device comprising circuitry configured to:
initiate a bidirectional transmit opportunity (TXOP) by transmitting, to the second communication device, a TXOP indicator indicating that a wideband TXOP is split into two channels and indicating that a first channel is primarily to be used for transmission of data from the first communication device to the second communication device and a second channel is primarily to be used for transmission of data from the second communication device to the first communication device;
transmit data to the second communication device on the first channel and listen for the reception of data from the second communication device on the second channel.

According to a further aspect there is provided as second communication device configured to bidirectionally exchange data with a first communication device, the second communication device comprising circuitry configured to:
receive, from the first communication device, a TXOP indicator to initiate a bidirectional transmit opportunity (TXOP), the TXOP indicator indicating that a wideband TXOP is split into two channels and indicating that a first channel is primarily to be used for transmission of data from the first communication device to the second communication device and a second channel is primarily to be used for transmission of data from the second communication device to the first communication device;
transmit data to the first communication device on the second channel and listen for the reception of data from the first communication device on the first channel.

According to still further aspects a computer program comprising program means for causing a computer to carry out the steps of the method disclosed herein, when said computer program is carried out on a computer, as well as a non-transitory computer-readable recording medium that stores therein a computer program product, which, when executed by a processor, causes the method disclosed herein to be performed are provided.

Embodiments are defined in the dependent claims. It shall be understood that the disclosed communication method, the disclosed computer program and the disclosed computer-readable recording medium have similar and/or identical further embodiments as the claimed communication devices and as defined in the dependent claims and/or disclosed herein.

One of the aspects of the disclosure is to identify a bidirectional TXOP by a TXOP identifier on two independent communication resources (i.e., communication channels). Each resource is used for a single communication direction except for response frames. The communication direction on both resources is inverse to each other.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a diagram of a communication scheme (frame exchange) illustrating the operation within a TXOP.

FIG. 2 shows a diagram of a communication scheme illustrating the operation with reverse direction grant (RDG).

FIG. 3 shows a communication scheme illustrating the operation with independent channels for different communication directions that are primarily used unidirectionally.

FIG. 4 shows a diagram of a communication scheme using a bidirectional frame exchange between two stations via two channels.

FIG. 5 shows a diagram of an embodiment of a communication scheme in which both channels are idle at the point in time of initiation of a bidirectional TXOP.

FIG. 6 shows a diagram of an embodiment of a communication scheme using initiation of a bidirectional TXOP with RTS/CTS exchange.

FIG. 7 shows a diagram of an embodiment of a communication scheme using bandwidth reduction because of non-idle channel.

FIG. 8 shows a diagram of an embodiment of a communication scheme illustrating bandwidth shrinking by CTS and Ind frame.

FIG. 9 shows a diagram of an embodiment of a communication scheme according to which STA 1 is waiting to access channel 1 in order to establish a bidirectional TXOP.

FIG. 10 shows a diagram of an embodiment of a communication scheme according to which STA 1 is reinitiating channel access on channel 1 in order to establish a bidirectional TXOP.

FIG. 11 shows a diagram of an embodiment of a communication scheme according to which a bidirectional TXOP is initiated when channel 2 is busy.

FIG. 12 shows a diagram of an embodiment of a communication scheme according to which bidirectional TXOP is terminated when there is a missing response in channel 2.

FIG. 13 shows a diagram of an embodiment of a communication scheme according to which a bidirectional TXOP is continued via RDG when there is a missing response in channel 2.

FIG. 14 shows a diagram of an embodiment of a communication scheme using synchronous PPDU transmission and reception in a bidirectional TXOP.

FIG. 15 shows a flowchart of a first communication method according to the present disclosure.

FIG. 16 shows a flowchart of a second communication method according to the present disclosure.

FIG. 17 shows a spectrum of an FDD operation.

FIG. 18 shows a diagram of the general layout of a communication scenario with two stations.

FIG. 19 shows a diagram of an embodiment of the procedure of the SI channel estimation and FDD operation according to the present disclosure.

FIG. 20 shows a diagram of an embodiment of the procedure of the SI channel estimation and FDD operation according to the present disclosure using multiple concurrent frames in FDD operation with renewed FDD initialization frame.

FIG. 21 shows a diagram of an embodiment of the procedure of SI channel estimation and FDD operation according to the present disclosure using multiple concurrent frames during FDD operation without renewed FDD initialization frame.

FIG. 22 shows a diagram of an embodiment of the procedure of SI channel estimation and FDD operation according to the present disclosure using shortened procedure of FDD operation.

FIG. 23 shows a diagram of an embodiment of the procedure of SI channel estimation and FDD operation according to the present disclosure using re-estimation of the SI channel.

FIG. 24 shows a diagram of an embodiment of the procedure of SI channel estimation and FDD operation according to the present disclosure using re-estimation of the SI channel after FDD operation.

FIG. 25 shows a diagram of an embodiment of the procedure of SI channel estimation and FDD operation according to the present disclosure using an FDD procedure for null data packets as estimation frame.

FIG. 26 shows a schematic diagram of an embodiment of the circuitry of a communication device used for SI channel estimation according to an embodiment.

FIG. 27 shows a schematic diagram of an embodiment of the circuitry of a communication device used for digital SIC in frequency domain according to an embodiment.

FIG. 28 shows a schematic diagram of an embodiment of the circuitry of a communication device used for SI channel estimation according to another embodiment.

FIG. 29 shows a schematic diagram of an embodiment of the circuitry of a communication device used for digital SIC in frequency domain according to another embodiment.

FIG. 30 shows a schematic diagram of an embodiment of the circuitry of a communication device used for digital SIC in time domain according to an embodiment.

FIG. 31 shows a diagram illustrating the magnitude of a spectrum for the case that the bandwidth of the UL signal is not equal to the bandwidth of the DL signal.

FIG. 32 shows a flowchart of a first communication method according to the present disclosure.

FIG. 33 shows a flowchart of a second communication method according to the present disclosure.

FIG. 34 shows a diagram of an embodiment of a communication scheme using estimation prior to the FDD communication phase

FIG. 35 shows the duplicate, wideband and single band format in more detail. In duplicate format, a frame is duplicated and transmitted on each channel.

FIG. 36 shows a diagram of an embodiment of a communication scheme using estimation and FDD communication in the same TXOP.

FIG. 37 shows a diagram of an embodiment of a communication scheme using separate FDD init frame for each frame exchange.

FIG. 38 shows a diagram of an embodiment of a communication scheme in with enhanced estimation phase.

### DETAILED DESCRIPTION OF THE EMBODIMENTS

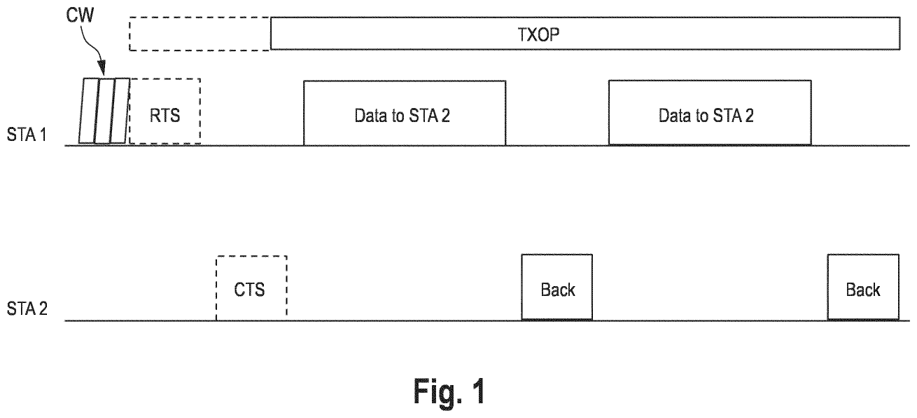

Referring now to the drawings, wherein like reference numerals designate identical or corresponding parts throughout the several views, FIG. 1 shows a diagram of a communication scheme illustrating the operation within a TXOP in which STA 1 is the TXOP initiator (also referred to as “first communication device”) and STA 2 is the TXOP responder (also referred to as “second communication device”). An RTS/CTS exchange may be present before the actual data frame exchange to protect the frame exchange. The contention period (also called “contention window”) CW may be provided either before the RTS frame or the first data transmission frame (left “Data to STA 2”). All frames shown in FIG. 1 are preferably separated by a short interframe spacing (SIFS) which may often have a duration of 16 μs.

In case the TXOP responder does not respond to the initially transmitted frame, the TXOP initiator considers this as a failed channel access. If successful, multiple frames may be transmitted by the TXOP initiator followed by a response by the TXOP responder until the TXOP duration is expired. The TXOP duration may be specified by the TXOP initiator within the initial frame or initial and subsequent frames.

For occasional reverse direction traffic, the so-called reverse direction grant (RDG) has been introduced as an optional mechanism. The TXOP initiator may indicate within a frame that the TXOP responder may add additional data to the response frame (preferably a separate data frame (or data unit), but optionally also included in the response frame). By doing so, small amounts of reverse (uplink) direction traffic (such as TCP/IP Ack) can be conveyed at the expense of reduced downlink traffic.

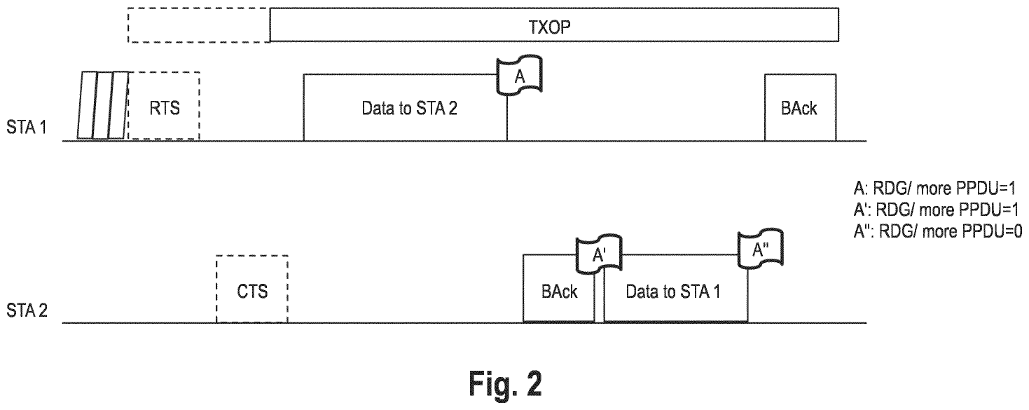

FIG. 2 shows a diagram of a communication scheme illustrating the operation with RDG. The TXOP initiator STA 1 may indicate, by RDG=1, that the TXOP responder STA 2 may add data frames to its response. The TXOP responder STA 2 may include in its response frame the indication MorePPDU=1 to indicate that it is going to transmit a data frame shortly (e.g. after a period SIFS) after the response frame. The following data frame sets MorePPDU=0 to indicate that STA 1 may continue the frame exchange (in this example by responding with a BAck frame). The indications “RDG/more PPDU” are the same indications, but have different meanings for an RDG initiator (STA 1) and an RDG responder (STA 2), respectively. For instance, according to IEEE 802.11-2020 there is one bit called “RDG/ore PPDU” that controls RDG protocol. Depending if the STA is an RD initiator (=TXOP initiator) or if it is an RD responder (=TXOP responder), the interpretation of this field is changing according to table 9-15 the standard:

| | Role of | |
|---|---|---|
| Value | transmitting STA | Interpretation of value |
| 0 | Not an RD responder | No reverse grant |
| | RD responder | The PPDU carrying the frame is the last |
| | | transmission by the RD responder |
| 1 | RD initiator | An RDG is present |
| | RD responder | The PPDU carrying the frame is followed |
| | | by another PPDU |

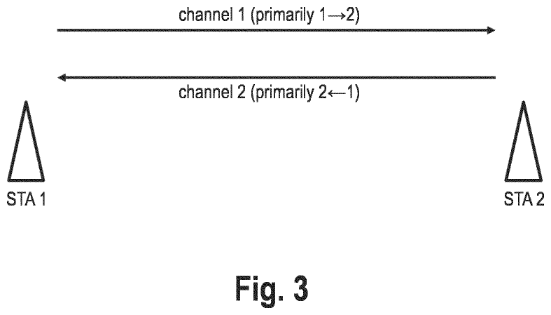

Future applications including virtual reality (VR), augmented reality (AR), and tele presence may require instantaneous downlink and uplink traffic supporting high data rates in both directions. FIG. 3 shows a communication scheme illustrating the operation with independent channels for different communication directions that are primarily used unidirectionally. One option is to implement instantaneous downlink and uplink in a communication system using two independent channels in which channel 1 is primarily used for downlink traffic, whereas channel 2 is primarily used for uplink traffic. The two independent channels may be created by frequency division duplex (FDD) over two channels at different carrier frequencies.

One potential issue in unlicensed bands is that both channels may have different busy/idle state, because they reside in different frequency bands where interference conditions may vary. Also, at the point in time of an initial transmission on channel 1, channel 2 may be not available or busy.

Another potential issue in unlicensed bands is that a certain structure of data transfer needs to be maintained in order that other communication devices do not assume the channel to be free and access the medium accidentally or that the changed state of busy/idle state can be observed by the initiating communication device or its peer. For this reason, a data transfer phase should be followed by a response phase. Also, regulatory defines a maximum time for data transfer phase as well as a maximum time for TXOP duration (sometimes also called channel occupancy time-COT). For this reason, a continuous one-directional traffic in a single channel is not desired.

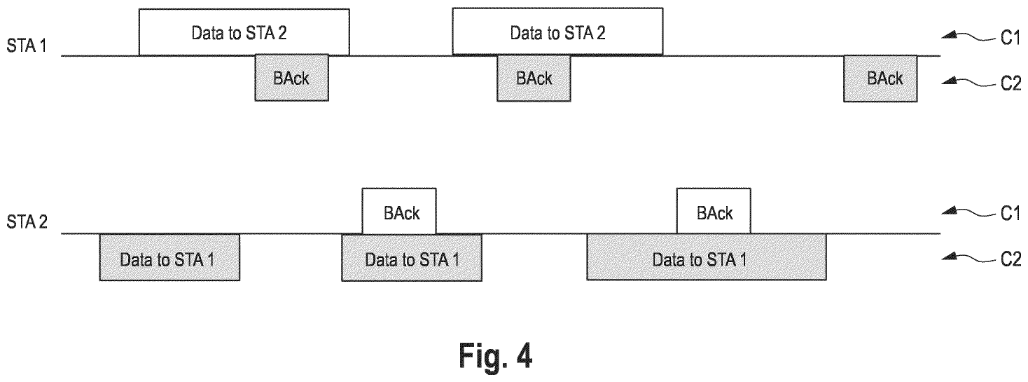

FIG. 4 shows a communication scheme using a bidirectional frame exchange between two STAs via two channels C1 and C2. Channel 1 (indicated as C1 in the drawings, which is the channel above the time line) is primarily used for data transfer from STA 1 to STA 2, whereas channel 2 (indicated as C2 in the drawings, which is the channel below the time line) is primarily used for data transfer from STA 2 to STA 1. On top of data transfer, each channel can carry response frames to e.g. acknowledge the data transmitted in the same (as shown in FIG. 4) and/or another channel. The response frame is present to avoid a continuous channel access.

One of the issues addressed in this disclosure is how to initiate and operate such a bidirectional frame exchange as shown in FIG. 4, which is referred to as bidirectional TXOP. A bidirectional TXOP is identified by a TXOP on two independent communication resources. The bidirectional TXOP is initiated by a TXOP initiator by sending a corresponding TXOP indicator, and two independent communication resources both are between bidirectional TXOP initiator and bidirectional TXOP responder. Each resource is used for a single communication direction except for response frames. The communication direction on both resources is inverse to each other.

In the following, STA 1 is the STA that initiates a bidirectional TXOP, whereas STA 2 is the responder to a bidirectional TXOP. Any STA may be an AP STA or a non-AP STA. Often, a bidirectional TXOP is established between an AP STA and a non-AP STA. Generally, the terms STA 1 and STA 2 are used as attributes and not as device names. Therefore, a single physical STA may act as a STA 1 or as a STA 2 at the same time. For example, if two physical STAs that are peer STAs to each other have data pending for a bidirectional TXOP, both will act as a STA 1 until a bidirectional TXOP is established by one STA. In fact, each STA does not know that it is a STA 2 before the bidirectional TXOP has been initiated. In this regard, also collisions may arise, i.e., two STAs try to establish a bidirectional TXOP at same time. The collision resolution is as in regular TXOP operation.

STA 1 may only be able to initiate a bidirectional TXOP when both, STA 1 and STA 2, support this feature and when an agreement between both STAs has been established before. This agreement may define parameters, operation modes, channels, bandwidth requirements, and traffic identifiers for which the bidirectional TXOP should be applied or is required. A corresponding traffic identifier may be attached to a data frame (MSDU) coming from a higher layer (e.g. type of service field in IPv4 or traffic class field in IPV6), or the station management entity (SME) may identify incoming traffic from a higher layer to be eligible for a bidirectional TXOP. If the SME identifies incoming traffic, a separate agreement such as a traffic specification (TSPEC) may be needed.

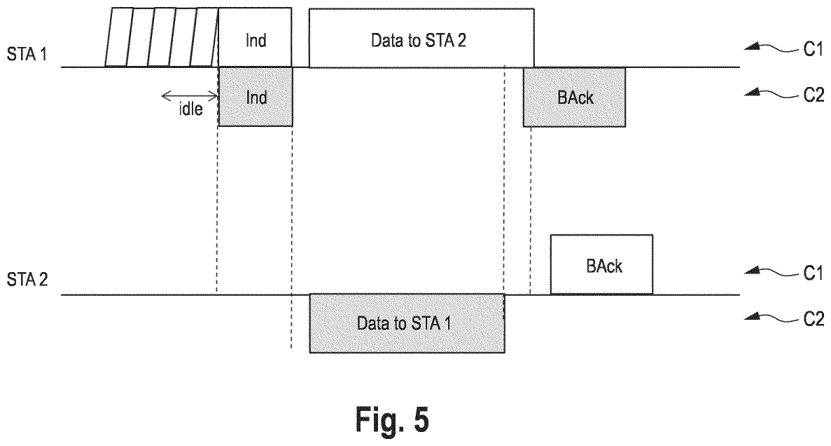

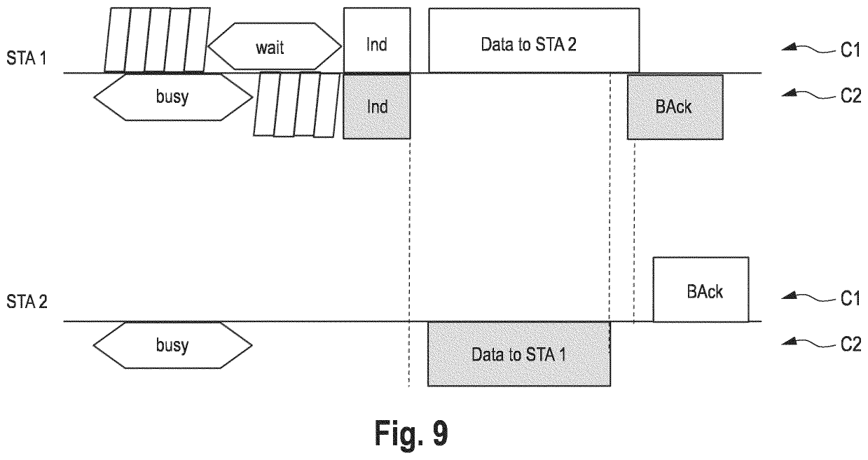

In the following, two cases are differentiated. The first case is illustrated in FIG. 5 showing a diagram of an embodiment of a communication scheme in which both channels are idle at the point in time of initiation of a bidirectional TXOP. The second case is illustrated in FIGS. 9 to 11. The second case assumes that channel 2 is non-idle or busy at the point in time of initiation of a bidirectional TXOP.

As will be elaborated as part of the second case, this second case is also applicable if channel 1 and channel 2 are non-adjacent and/or reside in different bands. Non-adjacent channels are channels in the sense that there is a significant frequency gap >80 MHz inbetween both channels.

As shown in FIG. 5, when STA 1 has one or more bidirectional TXOP eligible MSDUs pending for transmission within its queue, it performs channel access by counting down the CW value. If the channel is detected as idle when the CW value count down ended, STA 1 initiates a regular TXOP with STA 2 on channel 1. During an interval of PIFS before the initiation of the TXOP on channel 1, STA 1 also observes channel 2, and if it is detected as idle, it initiates a regular TXOP with STA 2 on channel 2, too. In such a case at least the first frame on channel 1 and channel 2 are transmitted synchronously; hence, a wide-band TXOP is initiated. A wideband TXOP is a TXOP that covers not only the primary 20 MHz channel but also one or more secondary (or non-primary) 20 MHz channels. STA 1 needs to support wideband operation that covers the bandwidth of channel 1 and channel 2 and, if needed, any small (e.g. less than or equal to 80 MHZ) guard band in between both channels.

It should be noted that in FIG. 5, it is assumed that channel 1 is the primary channel of the BSS and channel 2 is the secondary (or non-primary) channel. Therefore, the CW countdown happens on channel 1 and idle check of PIFS duration happens on channel 2. The definition of primary and secondary (or non-primary) channel holds for the entire BSS; hence, conceptually, when STA 2 would initiate a wideband TXOP, it would also perform the CW count down on channel 1.

The initiation of this TXOP may contain an indication (Ind) frame (the “TXOP indicator”) to at least STA 2 via channel 2 which indicates that the obtained wideband TXOP is split into two sub-bands channel 1 and channel 2. Furthermore, it indicates that STA 2 should use channel 2 primarily for frame exchanges to STA 1. Both indications take effect a time interval of SIFS after Ind ended or later if a subsequent frame exchange occurs which is for estimation purposes such as determination of self-interference transfer function. In such a case the Ind frame holds a related signaling such that STA 2 awaits further information in a subsequent frame, e.g. for configuration of the estimation phase. After that, STA 1 performs frame exchanges with STA 2 via channel 1, whereas STA 2 performs frame exchanges with STA 1 via channel 2 for either the entire TXOP duration or the duration indicated in the indication frame.

In an embodiment, the indication (Ind) may be sent in duplicate format (as shown in FIG. 5), meaning that each channel holds same (duplicated) information, or wideband format, meaning that the information is contained in both channels. The duplicate format has the advantage that STA 2 needs to observe and demodulate just one channel (i.e. channel 2). In another embodiment the Ind frame (“first TXOP indicator”) on channel 1 indicates that channel 1 shall primarily be used for transmission of data from STA 1 to STA 2 (i.e. any type of frame(s) are conveyed from STA 1 to STA 2 and only response frames go in inverse direction (i.e. STA 2 to STA 1)). The Ind frame (“second TXOP indicator”) on channel 2 indicates that channel 2 shall primarily be used for transmission of data from STA 2 to STA 1. In still another embodiment a common wideband Ind frame (“common wide-band TXOP indicator”) may be transmitted.

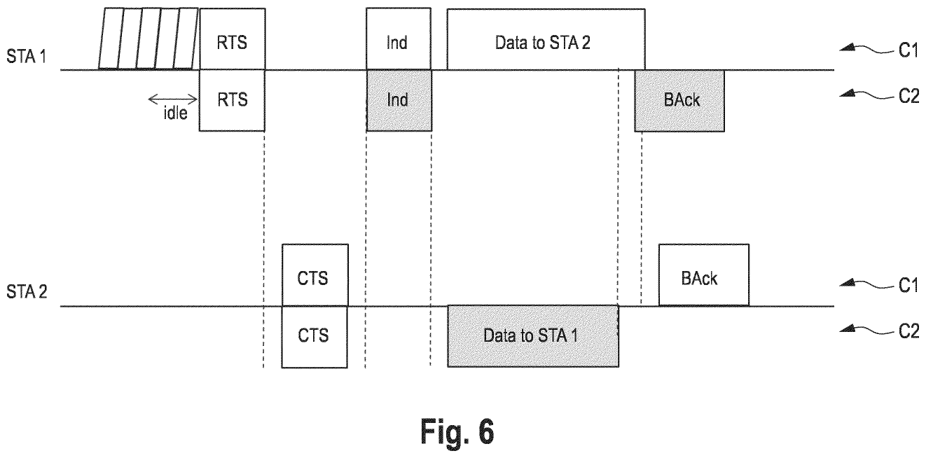

If the indication frame may be lost due to an overlapping transmission, STA 2 does not respond with “Data to STA 1” transmission in FIG. 5 to the Ind frame on channel 2 transmitted by STA 1. In such a case, STA 1 should try to initiate a bidirectional TXOP at a later point in time (e.g. as explained below as second case with reference to FIGS. 9 to 11). For this reason, it is preferred that the channel may be detected as idle at both STA 1 and STA 2. Therefore, an RTS/CTS exchange as illustrated in FIG. 6 showing a diagram of an embodiment of a communication scheme using initiation of a bidirectional TXOP with RTS/CTS exchange may be suitable.

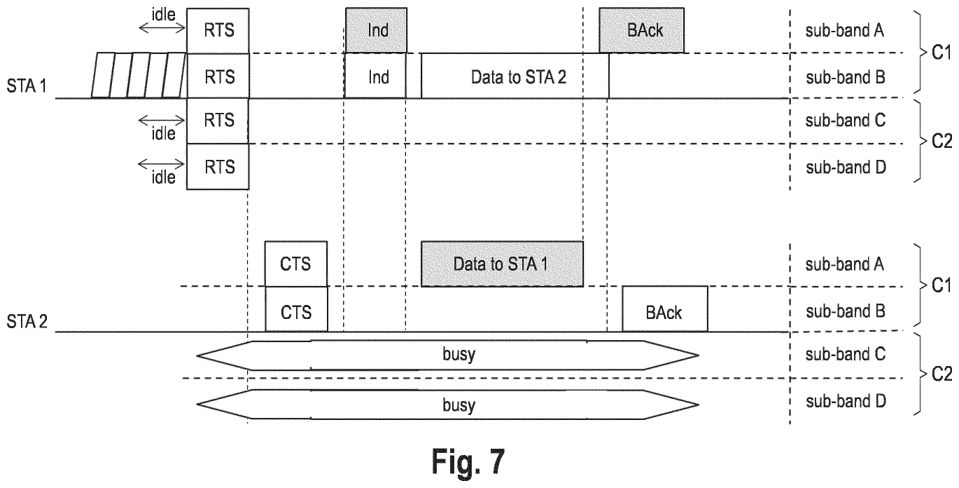

STA 1 transmits an RTS on the channels and/or sub-bands that the bidirectional TXOP should use and which are idle for an interval of PIFS before transmitting the RTS. Subsequently, STA 2 responds within SIFS with a CTS frame on those channels where it received the RTS and where its CCA indicates idle. Depending on the channel state (busy/idle) at STA 2, it may happen that the bandwidth of the bidirectional TXOP is shrunk. This information may be considered in the Ind frame by partially allocating channel 1 to STA 2 or channel 2 to STA 1, respectively. This is illustrated in FIG. 7 showing a diagram of an embodiment of a communication scheme using bandwidth reduction because of non-idle channel and partial assignment of channel 1 to STA 2. In this communication scheme two out of four sub-bands are non-idle which is indicated by STA 2 that is not transmitting CTS on the non-idle sub-bands. Therefore, STA 1 decides to split channel 1 by assigning sub-band A to STA 2 and by keeping sub-band B for its own frame exchange. The sub-bands may generally be sub-channels of a wideband channel or sub-bands of a channel of a wideband channel.

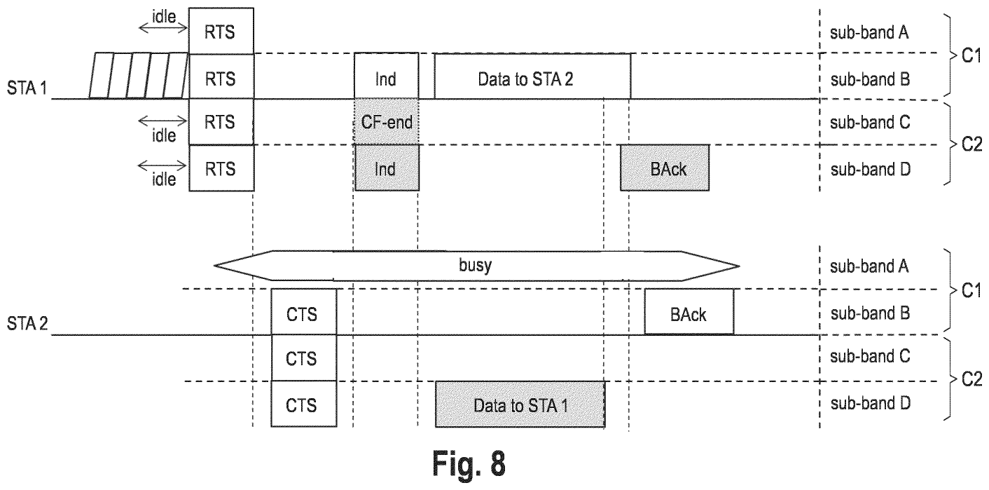

FIG. 8 shows a diagram of an embodiment of a communication scheme illustrating bandwidth shrinking by CTS and Ind frame. In this communication scheme each channel comprises two (or more) sub-bands. Sub-band B is assumed to be the primary channel, whereas all other sub-bands are assumed to be secondary channels (or non-primary channels). As explained above, it is further assumed that all sub-bands are detected as idle at the point in time when the RTS is transmitted from the perspective of STA 1. From the perspective of STA 2, sub-band A is busy, for which reason it does not transmit a CTS on sub-band A. The shrunk bandwidth would cause an asymmetry to the downlink and uplink data rates, which could be desired, e.g. if the application data traffic is asymmetric. This may be decided by the bidirectional TXOP initiator, e. g. based on the expected data transmission. However, if this is not desired, STA 1 can, as shown in FIG. 8, transmit the Ind frame on only two sub-bands, namely sub-band B and D to equalize both bandwidths. In order to free resources on sub-band C, STA 1 may transmit a CF-end frame which indicates to third party STAs that sub-band C is available. It is the decision of STA 1 which sub-bands to select for bidirectional communication if a sub-band or channel (in particular a non-primary sub-band or channel) is occupied. According to FIG. 8, STA 1 ceases from use of sub-band C, which increases the frequency separation of downlink and uplink sub-band which is favorable for interference conditions among both links.

The TXOP indicator (or indication frame) which splits the bandwidth of the initial (wide-band) TXOP into two parts, one for downlink and one for uplink, may be one of the following:
a) Reverse direction grant (RDG): The Ind frame sent on channel 2 by STA 1 grants to STA 2 the transmission of frames other than response frames by setting the RDG subfield to 1. Furthermore, STA 1 shall set the RDG subfield to 1 for every frame it transmits on channel 2 including response frames. It should avoid transmitting any frames except response frames for the duration of the bidirectional TXOP.
b) Contention free poll (CF-Poll): The Ind frame sent on channel 2 by STA 1 is a frame of subtype CF-Poll which transfers the TXOP ownership to STA 2 for the duration specified within the related subfield in CF-Poll subtype frames. As the TXOP ownership is transferred, STA 2 can use the TXOP in regular fashion as outlined in prior art section.
c) Single STA trigger frame (MU-RTS trigger frame): The Ind frame sent on channel 2 by STA 1 is a MU-RTS trigger frame with enabled TXOP sharing which transfers to TXOP ownership for channel 2 to STA 2. Subsequently, STA 2 can use the TXOP in regular fashion as outlined in prior art section.

Options b) and c) are frames, whereas for option a) is a subfield of any quality of service (QoS) frame. For option a) a QoS Null frame, i.e. a QoS frame holding no data, may be used, or a Control Wrapper frame to transfer the signaling together with any control frame such as Ack, BAck, RTS or CTS may be appropriate.

In particular, for option a), the first TXOP indicator may be a TBD frame (meaning a defined frame that controls the other STAs such that the envisioned operation is “triggered”), whereas the second TXOP indicator may be the same TBD frame but has the setting of RDG as described herein. There is no wideband (i.e. one wideband Ind frame) option for this example. For option b) the first TXOP indicator may be a TBD frame, whereas the second TXOP indication may be the same TBD frame but has the setting of CF-Poll as described herein. There is no wideband (i.e. one wideband Ind frame) option for this example. The settings of options a) and b) may reside in a subfield of the frames, i.e. MAC header of almost any data unit.

For option c), there are two variants (the first is most closest to implementation, the second may be supported in future): In the first variant the first TXOP indicator may be a TBD frame, whereas the second TXOP indication may be the single STA trigger frame. In the second variant there is one wideband TXOP indicator comprising a trigger frame that triggers communication from STA 1 to STA 2 on the first channel and communication from STA 2 to STA 1 on second channel.

In the following, the second case will be described, according to which channel 2 is non-idle at the point in time of initiation of a bidirectional TXOP. The Ind frame in the second case 2 illustrated in FIGS. 9 to 11 can be implemented via the three options as described above for the first case.

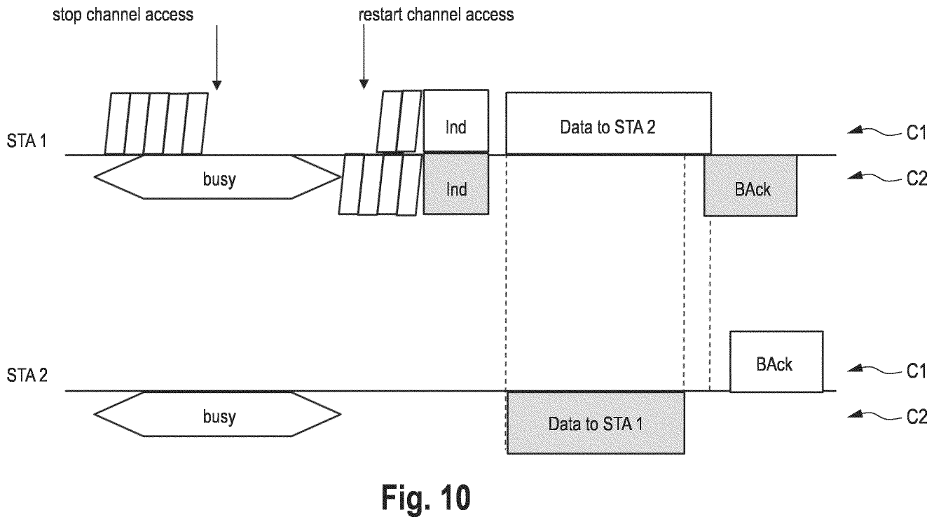

In case channel 2 is detected as busy (i.e. non-idle) at the point in time of TXOP initiation, there is the option to wait until both channels are detected as idle. This may imply that STA 1 waits after CW countdown until channel access is achieved on channel 2 (as illustrated in FIG. 9 showing a diagram of an embodiment of a communication scheme according to which STA 1 is waiting to access channel 1 in order to establish a bidirectional TXOP) and/or that STA 1 draws a new CW value for counting down in a subsequent idle phase of channel 1 (as illustrated in FIG. 10 showing a diagram of an embodiment of a communication scheme according to which STA 1 is reinitiating channel access on channel 1 in order to establish a bidirectional TXOP).

In the communication scheme shown in FIG. 10, the restart of channel access is done such that both channels can be accessed at the same time if both channels are idle. In the communication scheme shown in FIG. 9, when channel 1 gets non-idle, STA 1 shall restart channel access procedure with a new CW value. The mechanism of the communication scheme shown in FIG. 9 tends to be applicable if the waiting time is small, whereas the mechanism of the communication scheme shown in FIG. 10 tends to be applicable if the waiting time would be long, because a non-zero NAV (network allocation vector) is present on channel 2 for example.

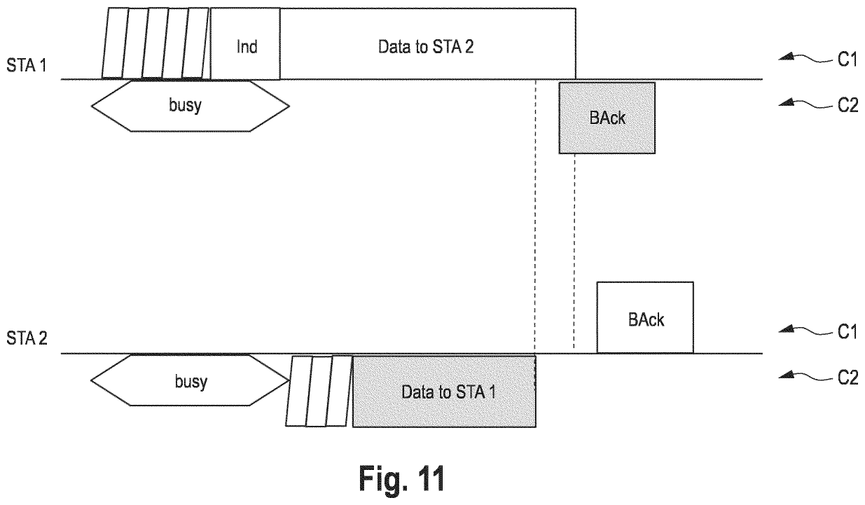

Another option is to access channel 1 and transmit an indication to STA 2 that a bidirectional TXOP should be initiated by STA 2 as soon as channel 2 is idle. The behavior is outlined in the following and illustrated in FIG. 11 showing a diagram of an embodiment of a communication scheme according to which a bidirectional TXOP is initiated when channel 2 is busy.

In the communication scheme shown in FIG. 11, when STA 1 has one or more bidirectional TXOP eligible MSDUs pending for transmission within its queue, it performs channel access by counting down the CW value. If the channel is detected as idle when the CW value count down ended, STA 1 initiates a regular TXOP with STA 2 on channel 1. Within this TXOP, preferably at the beginning, it transmits an indication (Ind) to STA 2 via channel 1. This indication makes STA 2 to contend for channel access and to establish a TXOP with STA 1 via channel 2 as soon as it detects channel 2 as idle. In contrast to the previous option, the indication frame for this option may be any frame as long as STA 2 can understand its content, because it does not affect other STAs than STA 2.

During the time interval until STA 2 can get channel access and the bidirectional TXOP is not yet established, the data flow is unidirectional. However, STA 1 may choose to apply reverse direction protocol until the bidirectional TXOP has been established like in the case when a channel gets unexpectedly busy (as described below). As a further option, STA 1 may transmit traffic to STA 2 that has no demand for bidirectionality until the bidirectional TXOP has been established.

When STA 2 gets finally access to the wireless medium, it may send some control frame to STA 1 on channel 2 such that STA 1 is aware of the successful channel access on channel 2. This indication may be helpful to align data units and/or to switch to bidirectional traffic and/or stop reverse direction protocol.

The variants depicted in FIGS. 9 to 11 are also applicable if channel 1 and 2 are non-adjacent and reside in different bands, because regulatory requires different CW values to be applied on each channel, i.e. the option illustrated in FIG. 5 with channel 2 being idle PIFS before initiation of a bidirectional TXOP may not work.

The end time of both TXOPs (esp. for the communication scheme shown in FIG. 11) that are established in different channels and form the bidirectional TXOP may vary because the TXOPs are established by different STAs. If this is not desired, the Ind frame may indicate the remaining TXOP duration of the TXOP established by STA 1 after the Ind frame has been transmitted. STA 2 measures the time until it gets channel access and subtracts this time for the signaled remaining TXOP duration and sets this time as its TXOP duration. By doing so, the end times of both TXOPs are aligned.

The following explanation is applicable for the first case and the second case: It may happen that due to interference one of both channels gets busy and cannot be used anymore. This may be detected by a missing response frame from the peer STA and/or a non-idle CCA. The STA that primarily transmits on the channel which is affected by interference stops data transfer. For the STA that primarily transmits on the channel which is not affected by interference, at least two options exist:

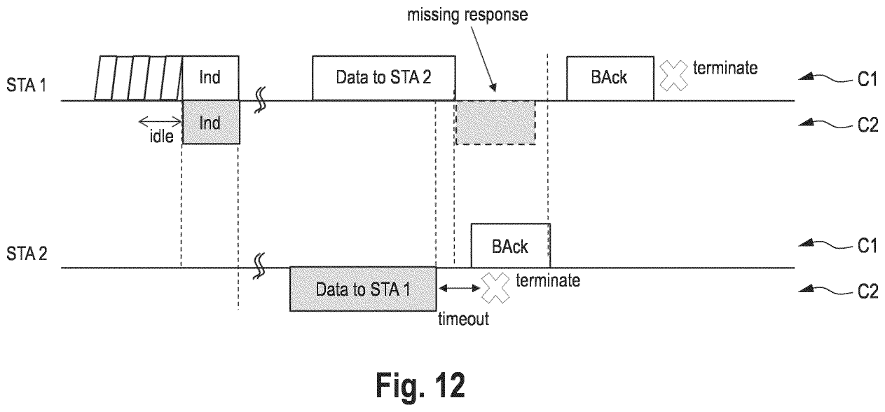

i) It terminates its TXOP by transmitting a CF-end frame. This means that the bidirectional TXOP is terminated. This option is illustrated in FIG. 12 showing a diagram of an embodiment of a communication scheme according to which bidirectional TXOP is terminated when there is a missing response in channel 2.

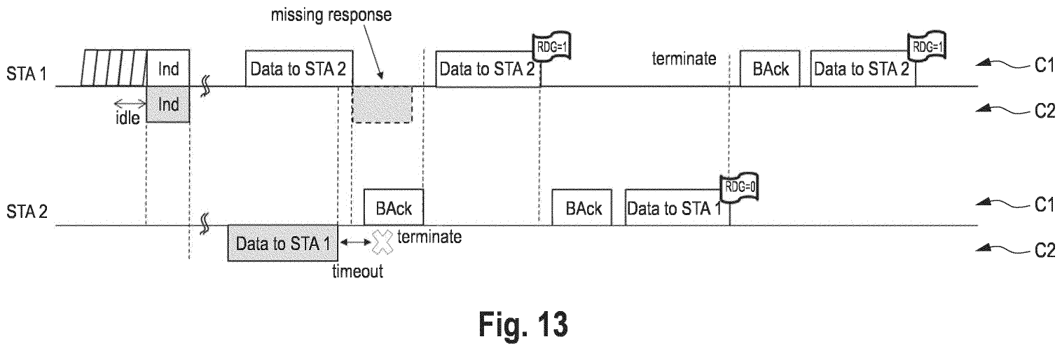

ii) It uses the RDG mechanism such that the bidirectional TXOP is maintained in time multiplex fashion on the channel not affected by interference. This option is illustrated in FIG. 13 showing a diagram of an embodiment of a communication scheme according to which a bidirectional TXOP is continued via RDG when there is a missing response in channel 2.

FIGS. 12 and 13 illustrate the case of a missing response. The operation in case of a non-idle CCA is analog. Often, in a frame exchange before a non-initial frame is sent, the CCA is only considered when there was a missing response before.

In order to reestablish a bidirectional TXOP via two channels, STA 1 may send an indication as the one shown in FIG. 5 (if channel 2 is idle) or as the one shown in FIG. 11 (if channel 2 is non-idle) in order to reestablish the link in reverse direction via channel 2. Once reestablished, the RDG on channel 1 should stop.

When the bidirectional TXOP is continued via RDG, as shown in FIG. 13, the achievable rate is at least halved, because the bandwidth of one channel is shared among downlink and uplink. If the target application cannot compensate, a different PHY configuration such as higher MCS or more spatial streams during RDG continuation can be envisioned.

Another option is to choose duplicated MPDUs (MAC layer data units) or a lower MCS than supported by the channel while two separate channels are available and to switch to a higher supported MCS or non-duplicated MPDUs during continuation via RDG. Thus, the error rate is lower while two separate channels are available as compared to the continuation via RDG when MCS is high or duplication is not present.

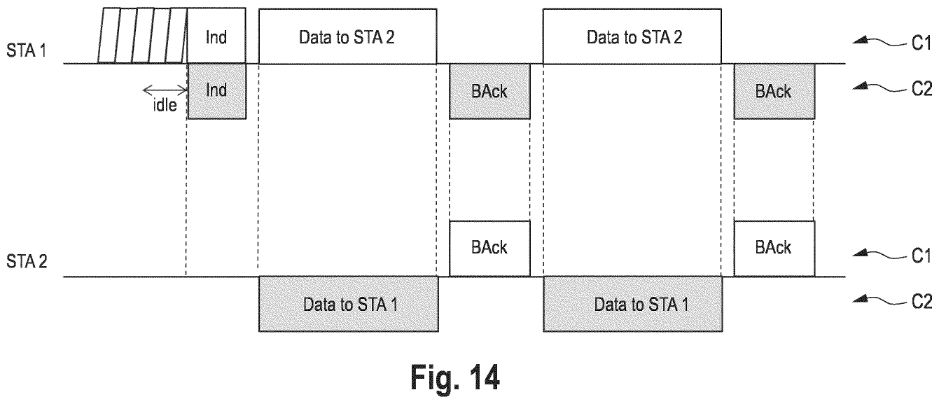

Once a bidirectional TXOP is established, it may be very useful to align PPDU start time and durations such that both channels operate synchronously. Thus, on each channel, STA 1 and STA 2 transmit or receive synchronously, or vice versa as illustrated in FIG. 14 showing a diagram of an embodiment of a communication scheme using synchronous PPDU transmission and reception in a bidirectional TXOP. When the alignment is very precise, e.g. to guard interval level of OFDM modulation, this may simplify self-interference suppression at each STA.

After an Ind frame has been transmitted on each link, the subsequent PPDUs have a same starting time on each channel already. Thus, for fully synchronous operation all subsequent PPDU durations as well as interframe spacings should be aligned. This can be achieved by signaling or agreement of PPDU durations during setup or by triggered PPDU transmission. The Ind frame may be combined or followed by a trigger frame transmitted by an (FDD) communication initiator to solicit transmission of a PPDU to STA 2 on channel 1 and a PPDU to STA 1 on channel 2 as well as a subsequent response frame (e.g. BAck) by the peer STA on each channel.

In case a PPDU duration cannot be met automatically, which may happen because of different data unit lengths and/or different PHY settings, a padding of the PSDU may be adequate to achieve a PPDU with the pre-agreed length. This also holds for response frames such as Ack or BAck which need to have same length and MCS.

In order to achieve synchronous operation after both channels operated asynchronously, because of an RDG continuation or because of a channel being not available at point in time of transmission initiation, STA 1 may send another Ind frame or a trigger to initiate one or more subsequent PPDUs after both channels are available.

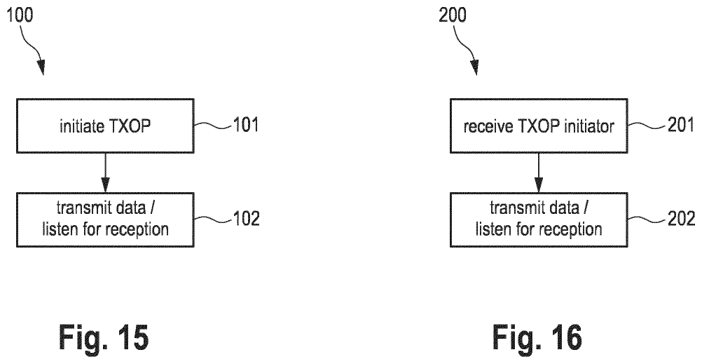

FIG. 15 shows a flowchart of a first communication method 100 according to the present disclosure. In a first step 101, a bidirectional transmit opportunity (TXOP) is initiated by transmitting, to the second communication device, a TXOP indicator indicating that a wideband TXOP is split into two channels and indicating that a first channel is primarily to be used for transmission of data from the first communication device to the second communication device and a second channel is primarily to be used for transmission of data from the second communication device to the first communication device. In a second step 102, data are transmitted to the second communication device on the first channel and listen for the reception of data from the second communication device on the second channel.

FIG. 16 shows a flowchart of a second communication method 200 according to the present disclosure. In a first step 201, from the first communication device, a TXOP indicator is received to initiate a bidirectional transmit opportunity (TXOP), the TXOP indicator indicating that a wideband TXOP is split into two channels and indicating that a first channel is primarily to be used for transmission of data from the first communication device to the second communication device and a second channel is primarily to be used for transmission of data from the second communication device to the first communication device. In a second step 202, data are transmitted to the first communication device on the second channel and listen for the reception of data from the first communication device on the first channel.

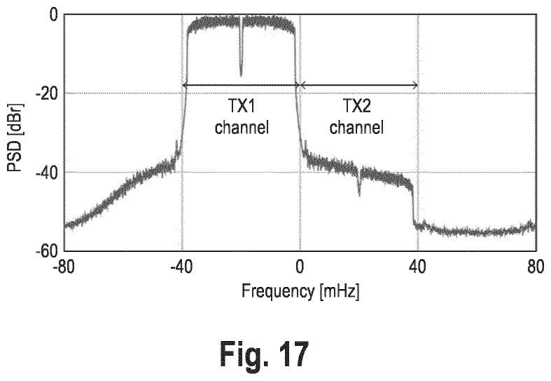

In the following further aspects of the present disclosure will be described, particularly dealing with self-interference. FIG. 17 shows a spectrum of an FDD operation, where uplink (channel 1) and downlink (channel 2) are directly adjacent. This FDD operation involves the problem of self-interference (SI), i.e., a non-negligible amount of the transmit signal leaks into the receiver receiving on TX2 channel in FIG. 17, caused by out-of-band emissions induced by every real transmitter. To alleviate the impact of self-interference, various self-interference cancellation (SIC) techniques can be applied, e.g., digital self-interference cancellation (DIC) techniques. SIC is usually done by means of SI signal estimation and subsequent subtraction from the received signal. For the estimation of the SI signal, it is important to properly estimate the SI channel, i.e., the transfer characteristic between transmitter and receiver of a device. With the knowledge of the actual transmit signal and the SI channel estimate, the SI signal estimate can be calculated and SIC can be performed.

For a bidirectional communication scenario, both devices firstly estimate their SI channels prior to FDD operation and secondly compensate the SI during FDD operation. In an embodiment of the present disclosure for the physical layer, SI channel estimation may be done by consecutive transmission of estimation frames. With the aid of the SI channel estimate, subsequent digital SI cancellation is enabled. In this disclosure, SI channel estimation as well as digital SIC, both suited for OFDM signals, are presented. Furthermore, the presented SIC approach method may use synchronization of the devices, with respect to OFDM symbol timing and carrier frequency offset (CFO). This is addressed with the transmission of an FDD initialization frame prior to FDD operation.

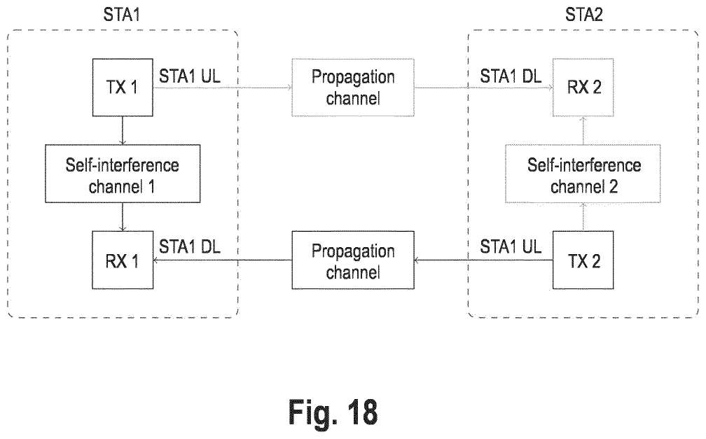

FIG. 18 shows a diagram of the general layout of a communication scenario with two stations STA 1 and STA 2, in which the present disclosure may be applied. The communication channel between STA 1 and STA 2 (here called propagation channel) can be assumed to be a wireless propagation channel like in regular TDD operation. Furthermore, STA 1 experiences an SI channel between its transmitter TX1 and its receiver RX1. STA 2 analogously experiences an SI channel, too.

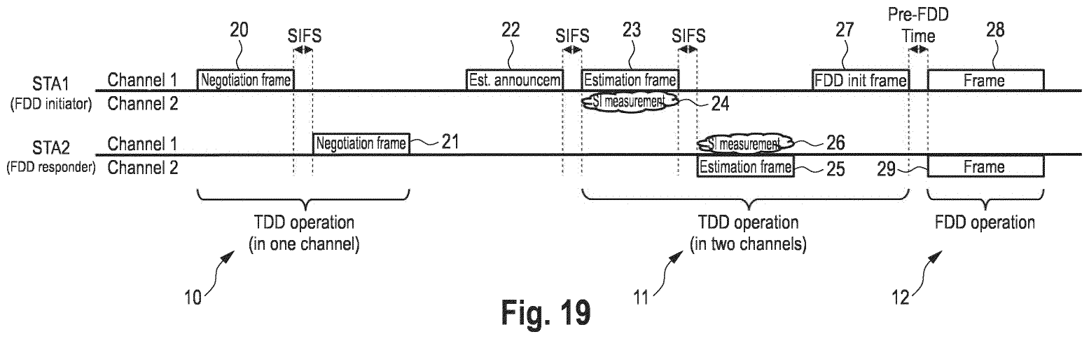

FIG. 19 shows a diagram of an embodiment of the procedure of the SI channel estimation and FDD operation according to the present disclosure.

Initially, in a first phase 10, the stations STA 1 and STA 2 operate in TDD operation in one channel (here channel 1). However, both are capable of FDD operation regarding their hardware. STA 1, the FDD initiator (herein also called “first communication device”), transmits an FDD negotiation frame 20 to notify STA 2 that it wants to enter FDD operation. The FDD negotiation frame 20 contains STA 1's FDD capabilities. More details about the negotiation frame will be described below. In this example, the uplink (UL) and downlink (DL) of STA 1 is assigned to channel 1 and channel 2, respectively. The UL and DL of STA 2 is assigned to channel 2 and channel 1, respectively. Channel 1 and channel 2 may be directly adjacent or separated by a gap or guard band. After a definite time interval, e.g., a short inter-frame spacing (SIFS), STA 2 sends a negotiation frame 21, which declares STA 2's FDD capabilities.

The FDD initiator STA 1 contends for both channels and gets a transmission opportunity for both channels. STA 1 transmits an estimation announcement frame 22 that defines the FDD configuration that shall be used by both stations for subsequent SI channel estimation and FDD operation. The estimation announcement frame 22 may hold an identifier that identifies the configuration used during estimation. This identifier may later be used by an FDD init frame 26 to indicate to STA 2 the appropriate self-interference measurement.

In a second phase 11, the stations STA 1 and STA 2 operate in TDD operation in two channels. After a definite time interval, e.g., a short inter-frame spacing (SIFS), STA 1 transmits an estimation frame 23 on channel 1 (more detailed properties of the estimation frame 23 will be described below). Concurrently, STA 1 measures the influence of the transmission of the estimation frame 23 (on channel 1) to channel 2. From this measurement, the SI channel estimate 24 of STA 1 can be determined. The SI channel estimate 24 is stored as well as the FDD configuration, transmit power, and optionally an identifier that has been used for SI channel estimation. Additionally, STA 1 determines the frequency offset between its transmitter TX1 and its receiver RX1. This frequency offset equals zero in case the reference frequencies in TX1 and RX1 originate from a same local oscillator, which resides within STA 1.

STA 2, the FDD responder (herein also called “second communication device”), receives the estimation frame 23 and sends subsequently an estimation frame 25 on channel 2 after a definite amount of time, e.g., a short inter-frame spacing (SIFS) after the first estimation frame 23. Concurrently, STA 2 measures the influence of the transmission of the estimation frame 25 (on channel 2) to channel 1. From this measurement, the SI channel estimate 26 of STA 2 can be determined. The SI channel estimate 26 as well as the FDD configuration and transmit power that has been used for SI channel estimation are stored. Additionally, STA 2 determines the frequency offset between its transmitter TX2 and its receiver RX2. This frequency offset equals zero in case the reference frequencies in TX2 and RX2 originate from a same local oscillator, which resides within STA 2.

The FDD initiator STA 1 sends an FDD initialization frame 27, which triggers STA 1 to transmit a frame 28 and STA 2 to transmit a frame 29 synchronously in a third phase 12 in which the stations STA 1 and STA 2 operate in FDD operation. The FDD initialization frame 27 also declares the FDD configuration for the FDD operation. Detailed properties of the initialization frame will be described below. In order to enable synchronous operation, STA 2 receives the FDD initialization frame 27 and determines the frequency offset between TX1 and RX2, based on this frame.

The stations start the transmission of their frames directly after a definite amount of time, e.g., after a short inter-frame spacing (SIFS). This ensures synchronization to each other with respect to OFDM symbol timing. Detailed properties of the concurrent frames will be described below. During FDD operation, STA 2 performs frequency offset correction to all its transmitted frames on channel 2 such that it compensates the frequency offset that has been determined with the previously received FDD initialization frame. By doing so, STA 2 operates frequency-synchronously to STA 1. Ideally, concurrent transmission of both stations (FDD operation) implies that both stations utilize SIC.

The proposed SIC method requires synchronization of STA 1 and STA 2 with respect to a carrier frequency offset (CFO)) between the transmitter of STA 1 and the transmitter of STA 2. This is due to the fact that a receiver can only be synchronized to either the desired signal from the distant station or to its own SI. This problem may be addressed by estimating the existing CFOs (at least the third FO, preferably all FOs) and pre-compensating for them during transmission.

In the following detailed description of this procedure, the deviations of the actual carrier frequencies from the nominal carrier frequencies of the transmitters of STA 1 and STA 2 are denoted as f_{T1} and f_{T2}, respectively. The deviations of the actual carrier frequencies from the nominal carrier frequencies of the receivers of STA 1 and STA 2 are denoted as f_{R1} and f_{R2}, respectively. The procedure of CFO estimation and compensation during estimation and FDD operation will be described in the following.

Implementation of the following steps will pre-compensate the third frequency offset CFO₃=f_{T1}−f_{T2}, if both devices have a non-zero frequency offset between their transmitter and receiver. Initially, STA 1 transceives (transmits and receives at same time in different frequency bands) an estimation frame and determines CFO between its transmitter and receiver: CFO₁=f_{T1}−f_{R1}. STA 2 transceives an estimation frame and determines CFO between its transmitter and receiver: CFO₂=f_{T2}−f_{R2}. Subsequently, STA 1 sends an initialization frame with pre-compensation of CFO₁: f_{T1,pre}=f_{T1}−CFO₁=f_{R1}, i.e. the carrier frequency of the transmitter is changed such that CFO₁ equals zero. STA 2 receives this initialization frame and determines mutual CFO_{M}=f_{T1,pre}−f_{R2}=(f_{T1}−CFO₁)−f_{R2}=f_{R1}−f_{R2}. Subsequently, STA 1 sends its FDD frame with pre-compensation of CFO₁: f_{T1,pre}=f_{T1}−CFO₁=f_{R1}. STA 2 sends its FDD frame with joint pre-compensation of CFO₂ and CFO_{M}: f_{T2,pre}=f_{T2}−CFO₂+CFO_{M}=f_{R1}. Hence, the third frequency offset CFO₃=f_{T1}−f_{T2} with enabled mentioned pre-compensations equals to: CFO₃=f_{T1,pre}−f_{T2,pre}=f_{R1}-f_{R1}=0. This means that both the desired signal and the SI are transmitted at the same frequency for both devices. Any STA can compensate the residual CFO f_{R1} with conventional methods, i.e., it synchronizes to the preambles of a PPDU to retrieve CFO and symbol timing and compensates accordingly.

Implementation of the following steps will pre-compensate the third frequency offset CFO₃=f_{T1}−f_{T2}, if both devices have no frequency offset between their transmitter and receiver, i.e., CFO₁=f_{T1}−f_{R1}=0 and CFO₂=f_{T2}−f_{R2}=0. STA 1 sends the initialization frame with f_{T1}. STA 2 receives this initialization frame and determines mutual CFO_{M}=f_{T1}−f_{R2}. CFO₂=0, f_{R2}=f_{T2} and CFO_{M}=f_{T1}−f_{T2} hold. STA 1 sends its FDD frame with f_{T1}. STA 2 sends its FDD frame with pre-compensation of CFO_{M}: f_{T2,pre}=f_{T2}+CFO_{M}=f_{T2}+f_{T1}−f_{R2}=f_{T1}. Hence, the third frequency offset CFO₃=f_{T1}−f_{T2} with enabled mentioned pre-compensation equals to: CFO₃=f_{T1}−f_{T2,pre}=f_{T1}−f_{T1}=0. This means that both the desired signal and the SI are transmitted at the same frequency for both devices. Any STA can compensate the residual CFO f_{T1} with conventional methods, i.e., it synchronizes to the preambles of a PPDU to retrieve CFO and symbol timing and compensates accordingly.

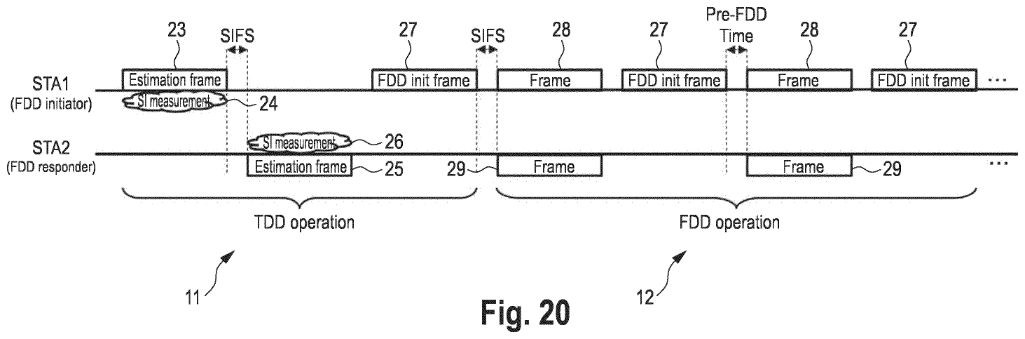

FIG. 20 shows a diagram of an embodiment of the procedure of SI channel estimation and FDD operation according to the present disclosure using multiple concurrent frames in FDD operation with renewed FDD initialization frame 27. After SI channel estimation, the stations may optionally interchange multiple concurrent frames 28, 29. The FDD initiator can initiate each concurrent frame exchange with an FDD initialization frame 27. After transmission of the FDD initialization frame 27 and a pre-FDD time interval, both stations concurrently interchange a frame 28, 29 on their respective channels. Each initialization frame 27 can declare a different FDD configuration that is used for the subsequent FDD operation, as long as the SI channel estimate 24, 26 for this exact configuration was previously determined and is therefore known. The configuration may be determined by the FDD configuration parameters or an identifier.

This procedure can last as long as the SI channel estimate is valid, which depends on the SI channel coherence time. Once the SI channel estimate is invalid or outdated, another estimation frame exchange may be made.

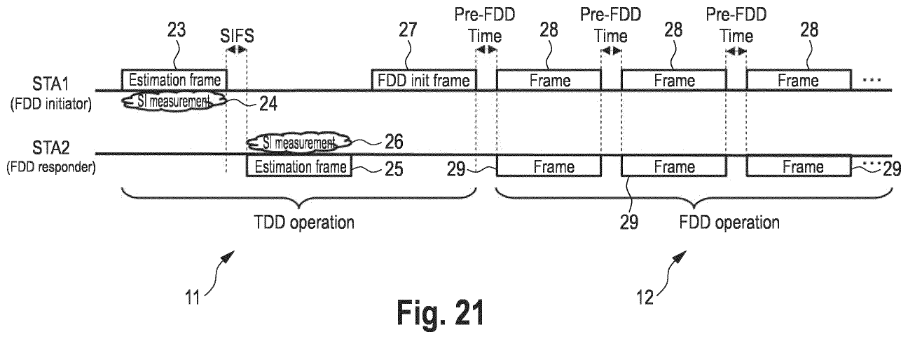

FIG. 21 shows a diagram of an embodiment of the procedure of SI channel estimation and FDD operation according to the present disclosure using multiple concurrent frames during FDD operation without renewed FDD initialization frame. After SI channel estimation, the stations may optionally interchange multiple concurrent frames 28, 29 without renewed transmission of the FDD initialization frame 27. The concurrent frames 28, 29 during FDD operation contain the information that more concurrent frames can be transmitted. In order to maintain a synchronous OFDM symbol timing, the following concurrent frames have to be transmitted exactly a pre-FDD time interval after the end of the concurrent frame that is transmitted by the FDD initiator. The length of the frames that are transmitted by the stations during FDD operation should be fixed. This length may be signaled in the FDD initialization frame 27 and is therefore known to both stations. The FDD configuration that was announced in the initialization frame 27 may be used during the whole FDD operation.

This procedure can last as long as the SI channel estimate is valid, which depends on the SI channel coherence time, and as long as the CFO estimate, which is determined at STA 2's reception of the FDD initialization frame, is valid. Generally, this principle may require very accurate synchronization of time and frequency among STA 1 and STA 2 which may not be implemented by all STAs. Therefore, usage of this feature may be subject to STA's capabilities.

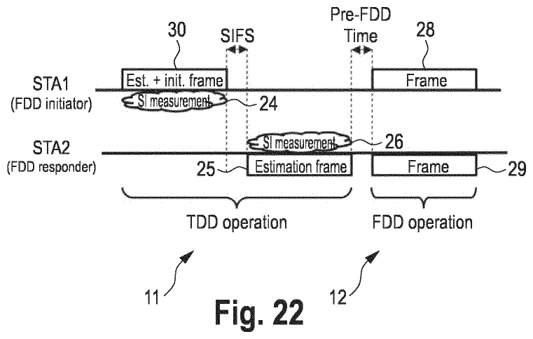

FIG. 22 shows a diagram of an embodiment of the procedure of SI channel estimation and FDD operation according to the present disclosure using shortened procedure of FDD operation. In order to shorten response time, the SI channel estimation frame and the FDD initialization frame may be combined in one frame 30. The estimation frame 25 of STA 2 may nevertheless be necessary. The concurrent frame exchange starts a pre-FDD time interval after the end of STA 2's estimation frame 25. However, this procedure may only be used if Rx and Tx of STA 1 have no frequency offset. The prerequisite of no frequency offset is met, e.g., if Rx and Tx of STA 1 use the same oscillator or if STA 1 knows the frequency offset between its Rx and Tx prior to estimation frame transmission or if STA 1 estimates this offset during transceiving a first part of the estimation frame and is thus able to compensate for it in a second part. In this case, STA 2 may estimate the frequency offset between the transmitter of STA 1 and the receiver of STA 2 based on the estimation and initialization frame 30 transmitted by STA 1.

Despite of working SIC and non-expired SI channel estimate, the reception during FDD operation can still be erroneous. This can be due to non-linear SI components caused by distortions of a non-linear power amplifier. These distortions can be avoided or reduced if the transmit power of a station is reduced. This comes at the expense of reduced signalto-interference-and-noise ratio at the other station. It should be determined whether non-linear components have a significant contribution to SI.

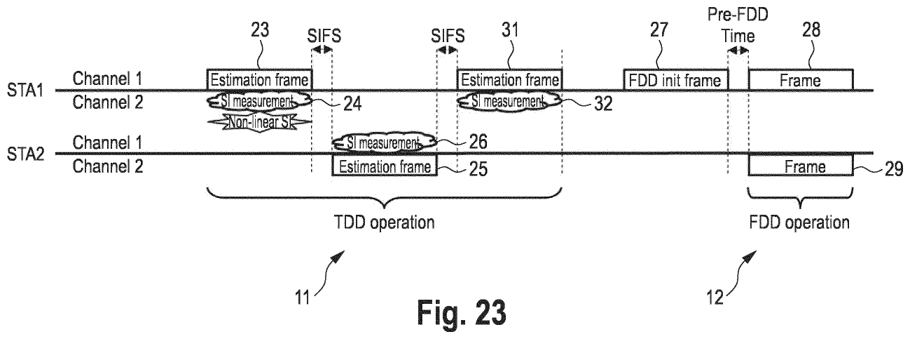

FIG. 23 shows a diagram of an embodiment of the procedure of SI channel estimation and FDD operation according to the present disclosure using re-estimation of the SI channel. STA 1 experiences increased non-linear SI components during its SI channel estimation. After SI channel estimation of STA 2, STA 1 repeats its SI channel estimation with reduced transmit power by transmitting another estimation frame 31 and determining an SI channel estimate 32. If STA 1 accepts the level of non-linear SI, FDD operation can be initialized.

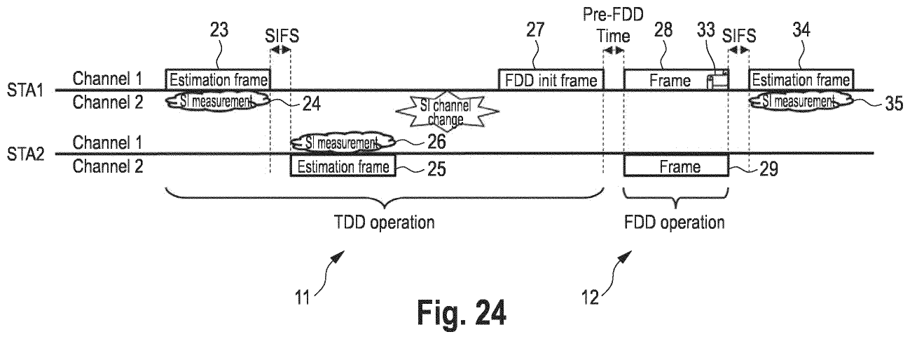

FIG. 24 shows a diagram of an embodiment of the procedure of SI channel estimation and FDD operation according to the present disclosure using re-estimation of the SI channel after FDD operation. This operation may be applied in case that a high level of SI occurs despite of active SIC. With the first estimation frame 23, STA 1 determines the SI channel estimate as explained above. The SI channel of STA 1 changes significantly. During concurrent frame exchange in FDD operation 12, STA 1 experiences SI leading to high errors despite of active SIC. STA 1 recognizes the expired SI channel estimate and transmits a notification 33 within the concurrent frame 28 to tell the other station that it requires re-estimation of its SI channel. After a definite amount of time (e.g., a SIFS), STA 1 transmits an estimation frame 34 and determines a new SI channel estimate 35. An FDD initialization frame may be transmitted to re-initiate FDD operation (not shown in the figure).

One or more (preferably all) of the following parameters may be used as transmission parameters that may also be referred to as FDD configuration: The channels that the stations use during SI channel estimation or FDD operation; the subcarrier spacing that the stations use during SI channel estimation or FDD operation; and the guard interval length that the stations use during SI channel estimation or FDD operation.

The negotiation frame 20 (see e.g. FIG. 19) is transmitted in TDD operation and initiates a negotiation between two stations that aim to interchange the FDD-related capabilities of the stations. The negotiation can persist a long time, i.e., a renewed negotiation needs not to be done after every frame exchange in FDD operation. The negotiation frame 20 may particularly contain one or more of the following information: information which FDD configurations this station is capable of; information which bandwidths this station is capable of using for FDD operation; information, whether the shortened alternative procedure is supported; and information which maximum FDD frame length this station is capable of using for FDD operation.

The estimation announcement frame 22 (see FIG. 19) declares the FDD configuration that should be used by both stations for the subsequent SI channel estimation. This ensures that SIC can work properly.

One or more (preferably all) of the following prerequisites should be met for the estimation frame 23, 31, 34 in order to ensure that the SI channel estimate is valid for the FDD operation: The estimation frame should use the FDD configuration that was declared in the estimation announcement frame. The estimation frame should contain known sequences in order to allow frequency offset estimation and timing offset estimation methods to work (e.g., long training field-LTF in WLAN). The estimation frame should contain at least one OFDM symbol covering all data subcarriers, in order to incorporate all data subcarriers for SI channel estimation. This OFDM symbol can be part of the estimation sequence (e.g., LTF in WLAN). The estimation frame should contain at least one known sequence for the estimation of the strength of non-linear SI components. The estimation frame may contain a non-empty data field (e.g., PSDU) containing payload from higher layers. The estimation frame may contain another field for frequency offset estimation, in order to allow firstly estimation of the frequency offset between Tx and Rx of the same device and secondly estimation of the mutual frequency offset between the stations. If relevant, MCS may change between estimation frame and FDD operation.

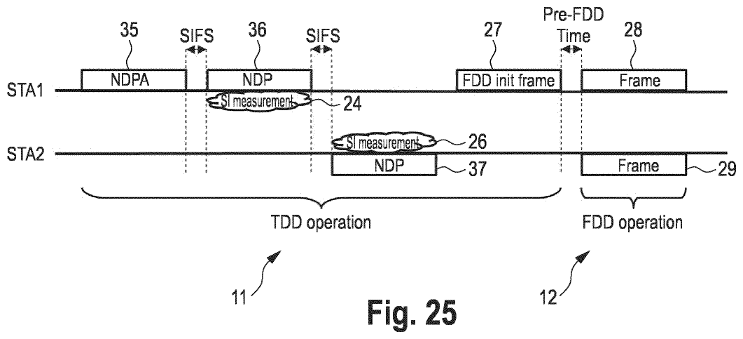

FIG. 25 shows a diagram of an embodiment of the procedure of SI channel estimation and FDD operation according to the present disclosure using an FDD procedure for null data packets (NDPs) as estimation frame. An estimation frame may be implemented by an NDP 36. The NDP may before be announced by a null data packet announcement (NDPA) 35 transmitted by the FDD initiator. The NDPA would then correspond to the estimation announcement frame 22. The FDD responder may not transmit an NDPA, but only an NDP 37 for SI channel estimation. The NDPA 35 and the subsequent NDPs 36, 37 may be separated by a SIFS. In this case, the SI channel estimation is performed through NDP transmission and its concurrent reception. The NDP shall comply with the above-described properties.

The initialization frame 27, which is sent by the FDD initiator to announce FDD operation, should meet one or more (preferably all) of the following requirements. The initialization frame should contain known sequences in order to allow frequency offset estimation and timing offset estimation methods to work (e.g., LTF in WLAN). The initialization frame should contain the information that FDD operation can begin after reception of this frame. The initialization frame should contain the length of the frame that will be subsequently transmitted by the stations during FDD operation. The initialization frame should contain the information which FDD configuration shall be used in the subsequent FDD operation. It has to be ensured that an SI channel estimate for exactly this configuration has been determined previously by both stations and is therefore known and did not expire. Optionally, the initialization frame and the estimation frame may be contained within the same PPDU, i.e., SI channel estimation and FDD initialization may be done with one frame. The initialization frame may be implemented by a trigger frame that triggers STA 1's and STA 2's subsequent transmission(s). Nevertheless, it should comply with the properties above.

The frames 28, 29 that are concurrently interchanged by the stations during FDD operation 12 should meet one or more (preferably all) of the following requirements. The concurrent FDD frames should contain known channel estimation sequences in order to allow frequency offset estimation and timing offset estimation methods to work (e.g., LTF in WLAN). The concurrent FDD frames of both stations should have the same length, i.e., both have the length which was specified before in the initialization frame. If the data unit length of any station does not match the specified length, a padding of the PSDU and/or PPDU may be appropriate to align the concurrent transmission. Hence, the concurrent transmission ends simultaneously. The concurrent FDD frames should use the FDD configuration that was declared in the initialization frame. The transmit power during FDD operation should be the same as the transmit power that has been used during the determination of the SI channel estimate that matches to the actually used FDD configuration because transmit power can change the amount of out-of-band emissions and thus the strength of SI. The concurrent FDD frames may contain the information that another concurrent frame will follow after the current concurrent frame. In the context of the present disclosure the data units may be PPDUs that hold user data. The frames may control operation of WLAN (often control frames) and may reside in a PPDU alone or together with other frames.

SI cancellation for FDD operation in adjacent channels may be realized in different ways. In the following, two embodiments will be described. In a variant A of a first embodiment there exists a link between Tx and Rx of a station, in order to use the actual transmit signal for calculation of the SI estimate. In a variant B of a second embodiment the transmit signal for calculation of the SI estimate is determined by receiving and demodulation of the own transmit signal.

Generally, it is not possible to combine SI channel estimation and SIC of different variants, e.g. SI estimation according to variant A and SIC according to variant B, or vice versa. This is because SI channel estimation method used according to variant A refers the SI channel estimate on the ideal, originally transmitted UL signal, but SI channel estimation method used according to variant B refers the SI channel estimate on the received UL signal passed through the SI channel.

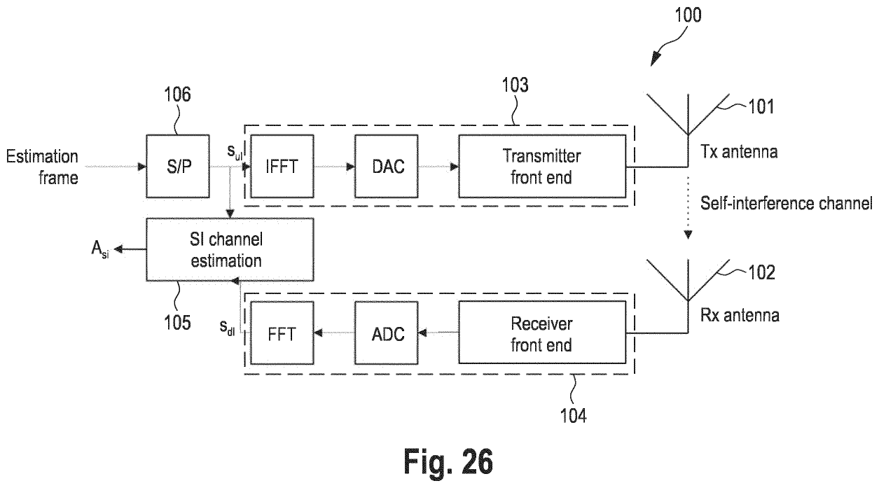

FIG. 26 shows a schematic diagram of an embodiment of the circuitry 100 of a communication device used for SI channel estimation according to variant A. The circuitry 100 comprises a Tx antenna 101, an Rx antenna 102, transmitter circuitry 103, receiver circuitry 104, channel estimation circuitry 105 and serial-to-parallel conversion circuitry 106.

SI channel estimation according to variant A is performed in the frequency domain, i.e., the estimation method determines a complex value for each subcarrier of the DL channel. For this purpose, the following signals should be known: i) The frequency-offset-compensated, OFDM-demodulated SI measurement signal s_{dl} received in the DL channel during transmission of SI estimation frame (the variable s_{dl} denotes a vector whose elements contain the received signal in each OFDM subcarrier of the DL channel); and ii) the actual transmitted signal sᵤₗ of the SI estimation frame prior to OFDM modulation, but after S/P (the variable sᵤₗ denotes a vector whose elements contain the transmitted signal in each OFDM subcarrier of the UL channel). With the knowledge of these signals, the frequency domain SI channel estimate can be calculated as Aₛᵢ=s_{dl} Øsᵤₗ, where Ø denotes the element-wise division.

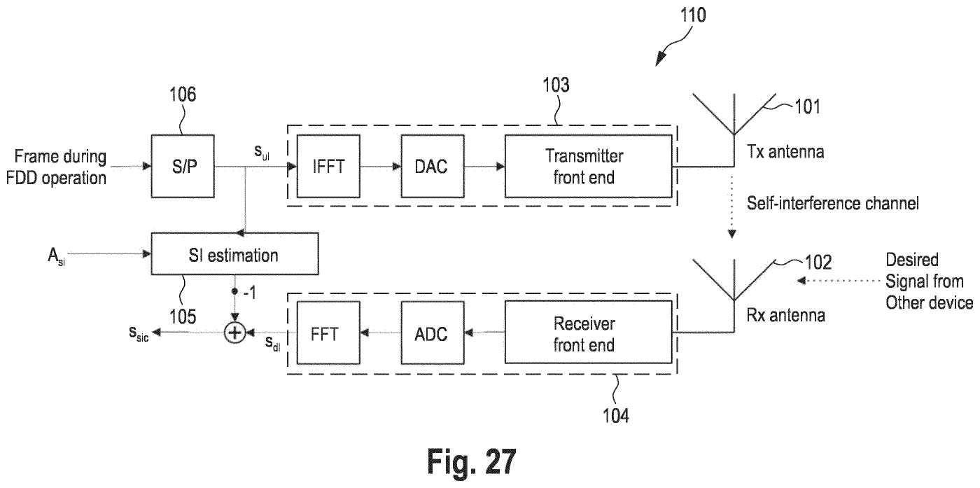

FIG. 27 shows a schematic diagram of an embodiment of the circuitry 110 of a communication device used for digital SIC in frequency domain according to variant A. Digital SIC is performed during FDD operation after SI channel estimation and FDD initialization. The method determines a self-interference estimate that is subsequently subtracted from the received signal. This method aims to mitigate linear SI components that are caused by spectral aliases that are, e.g., insufficiently suppressed in the transmitter digital-to-analog converter (DAC) or caused by spectral folding in the receiver analog-to-digital converter (ADC).

For the digital SIC method in the frequency domain, one or more (preferably all) of the following signals should be known. The actual transmitted signal sᵤₗ of the UL channel prior to OFDM modulation (the variable sᵤₗ denotes a vector, whose elements contain the transmitted signal in each OFDM subcarrier of the UL channel); the SI channel estimate Aₛᵢ (this estimate was previously determined by means of the estimation frames); and the frequency-offset-compensated, OFDM-demodulated, received signal s_{dl} in the DL channel, which is a superposition of the desired signal and SI (the variable s_{dl} denotes a vector whose elements contain the received signal in each OFDM subcarrier. The SI estimate may be calculated as sₑₛₜ=Aₛᵢ ⊙sᵤₗ, where ⊙ denotes the element-wise (subcarrierwise) multiplication. In order to cancel SI, the SI estimate is subtracted from the received signal s_{sic}=s_{dl}−sₑₛₜ.

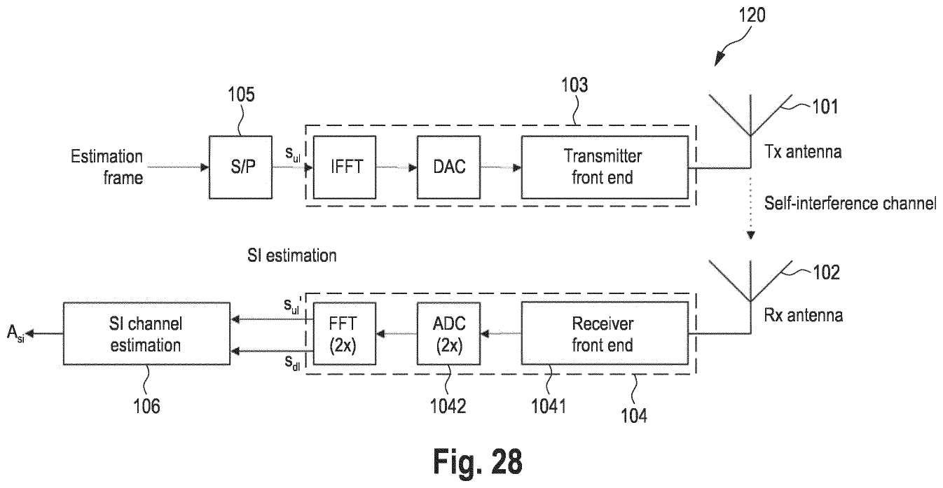

FIG. 28 shows a schematic diagram of an embodiment of the circuitry 120 of a communication device used for SI channel estimation according to according to variant B. SI channel estimation is performed in frequency domain, i.e., the estimation method determines a complex value for each subcarrier of the DL channel. For this purpose, the following signals should be known: The frequency-offset-compensated, OFDM-demodulated SI measurement signal s_{dl} received in the DL channel during transmission of SI estimation frame (the variable s_{dl} denotes a vector whose elements contain the received signal in each OFDM subcarrier of the DL channel); and the received, frequency-offset-compensated and OFDM-demodulated signal sᵤₗ′ on the UL channel during transmission of the SI estimation frame (the variable sᵤₗ′ denotes a vector whose elements contain the received signal in each OFDM subcarrier of the UL channel).

With the knowledge of these signals, the frequency domain SI channel estimate can be calculated as Aₛᵢ=s_{dl} Ø sᵤₗ′, where Ø denotes the element-wise division. Compared to variant A, this variant has a number of differences: The receiver front end 1041 is tuned in such a way to receive both the UL and the DL signal. The receiver front end 1041 may include appropriate filtering circuitry, e.g., surface-acoustic-wave filters, to prevent ADC saturation caused by the strong UL signal.

Further, the ADC 1042 requires a sampling rate of double the maximum of the bandwidths of the UL and DL signal, fₛ=2·max (B_{UL}, B_{DL}). This ensures that the ADC 1042 is capable of properly sampling both the UL and the DL signal. Furthermore, the ADC 1042 should have a high resolution to prevent high quantization noise induced by the high power difference between UL and DL signal. For OFDM demodulation, a double-sized FFT may be used to jointly demodulate the UL and DL signal. Selection of the appropriate subcarriers is required to obtain both the signal sᵤₗ′ in the UL and in the DL subcarriers s_{dl}.

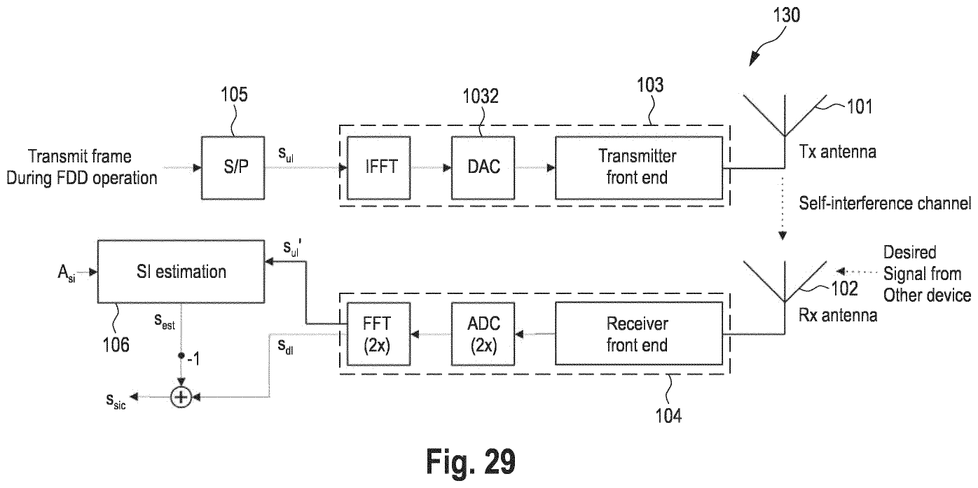

FIG. 29 shows a schematic diagram of an embodiment of the circuitry 130 of a communication device used for digital SIC in frequency domain according to variant B. Digital SIC is performed during FDD operation after SI channel estimation and FDD initialization. The method determines a self-interference estimate that is subsequently subtracted from the received signal. This method aims to mitigate linear SI components that are caused by spectral aliases that are, e.g., insufficiently suppressed in the transmitter digital-to-analog converter (DAC) or caused by spectral folding in the receiver analog-to-digital converter (ADC). 1032.

For the digital SIC method in frequency domain, the following signals should be known: The frequency-offset-compensated, received and OFDM-demodulated signal sᵤₗ′ of the UL channel (the variable sᵤₗ′ denotes a vector, whose elements contain the transmitted signal in each OFDM subcarrier of the UL channel); the SI channel estimate Aₛᵢ (this estimate was previously determined by means of the estimation frames); and the received frequency-offset-compensated, OFDM-demodulated signal s_{dl} in the DL channel, which is a superposition of the desired signal and SI (the variable s_{dl} denotes a vector whose elements contain the received signal in each OFDM subcarrier). The SI estimate is calculated as sₑₛₜ=Aₛᵢ ⊙sᵤₗ′, where (denotes the element-wise multiplication. In order to cancel SI, the SI estimate is subtracted from the received signal s_{sic}=s_{dl}−sₑₛₜ.

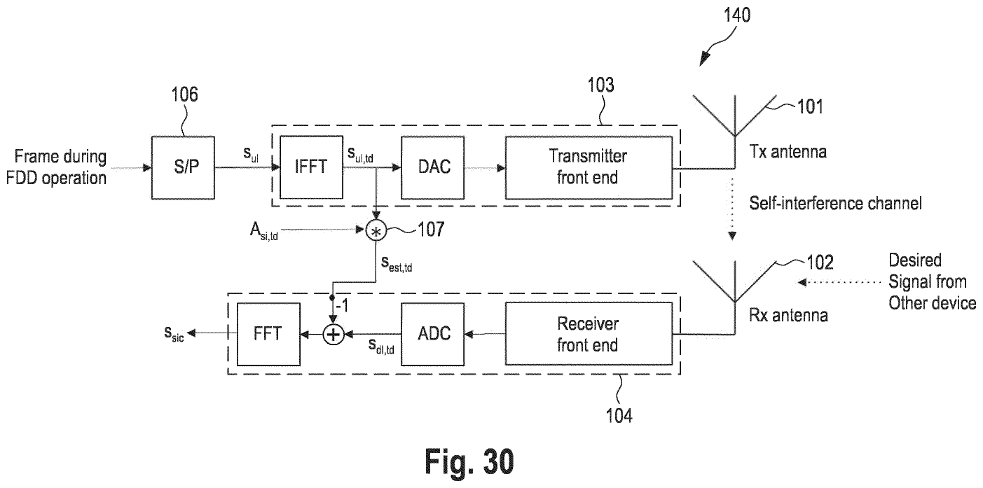

The variants A and B described above assume operation in frequency domain. This means that determination of Aₛᵢ and sₑₛₜ in each case are derived by computations (division or multiplication) with frequency-domain signals. It should be noted that, equivalently, those computations can also be performed in time domain. FIG. 30 shows a schematic diagram of an embodiment of the circuitry 140 of a communication device used for digital SIC in time domain.

For example for variant A, sₑₛₜ=Aₛᵢ⊙sᵤₗ is the representation in frequency domain for variant A, respectively. It is possible to transform Aₛᵢ in time domain by inverse Fourier transform and obtain Aₛᵢ,td, which can be considered as a self-interference impulse response. The time-domain counterpart s_{ul,td} of the signal sᵤₗ can be determined by obtaining the signal after IFFT shown in FIG. 30 for variant A. With s_{ul,td} and Aₛᵢ,td, it is possible to obtain the time-domain self-interference estimate by s_{est,td}=A_{si,td} [symbol] s_{ul,td}. The [symbol] operator 107 denotes convolution and can be implemented by a digital filter for example. The signal sₑₛₜ,td is subtracted before FFT operation in the embodiment shown in FIG. 30 because it is a time-domain cancellation signal. Alternatively, it may be transferred in frequency domain by Fourier transform and being subtracted in frequency-domain similarly to what is shown in FIG. 27. Although the previous embodiment refers to variant A, generally, the time-domain processing can be also envisioned for variant B and FIG. 30.

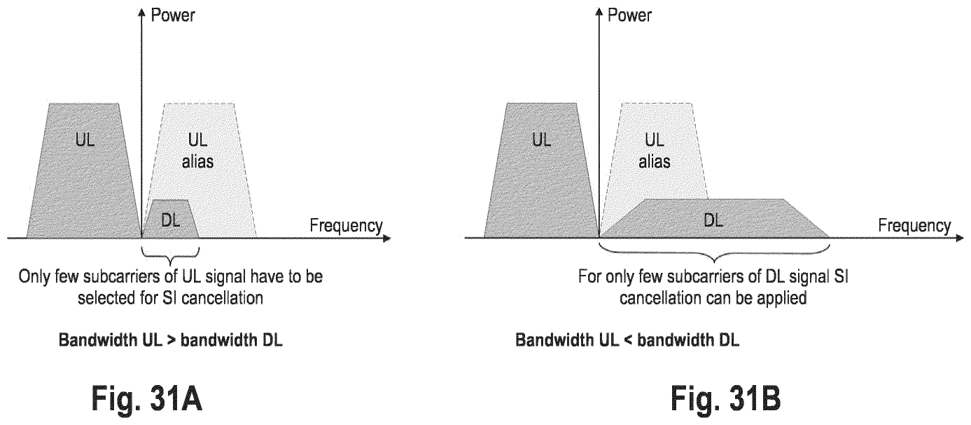

FIG. 31 shows diagrams illustrating the magnitude of a spectrum for the case that the bandwidth of the UL signal is not equal to the bandwidth of the DL signal. FIG. 31A shows the case where the UL bandwidth is larger than the DL bandwidth. FIG. 31B shows the case where the UL bandwidth is smaller than the DL bandwidth.

The above-described estimation and cancellation algorithms implicitly assume that both stations use the same bandwidth, i.e., the signals s_{dl} and sᵤₗ (or sᵤₗ′, respectively) have the same dimension. However, this may not be the case in every scenario and therefore requires proper subcarrier selection. In the following, the case is considered that the bandwidths do not match.

As the proposed cancellation method aims to suppress SI coming from aliasing artifacts, an imaginary spectral alias is plotted in FIG. 31. Obviously, only a portion of the UL alias overlaps with the DL signal or only a portion of the DL signal overlaps with the UL alias, respectively. The set of subcarriers of the DL signal, that are overlapped by the non-zero subcarriers of the UL alias, are denoted as M_{DL}. The corresponding set of subcarriers of the UL alias, that overlap with the DL signal, are denoted as M_{UL}. It holds |M_{DL}|=|M_{UL}|, where |⋅| denotes the cardinality of a set.

If the outcome of the OFDM-demodulation (FFT) of the DL signal in variant A or B shown in FIGS. 26 to 29 is denoted as S_{F,DL}, the signal s_{dl} should be determined as s_{dl}=S_{F,DL} {M_{DL}}, where {⋅} denotes the selection of those elements in the vector defined in the given set. If the UL transmit signal in variant A prior to IFFT is denoted as S_{F,UL}, the subcarriers of the signal sᵤₗ should be selected as sᵤₗ=S_{F,UL} {M_{UL}}. If the received UL signal in variant B after (double-sized) FFT is denoted as S_{F,UL}′, the subcarriers of the signal sᵤₗ′ should be selected as sᵤₗ′=S_{F,UL}′ {M_{UL}}. These selections should be performed during both the SI channel estimation and the cancellation period.

The following procedure may be used to determine the strength of non-linear SI components during estimation period, regardless of variant A or B. If the new SI channel estimate slightly deviates from the old SI channel estimate, the errors likely come from non-linear SI components. The station estimates the SI channel estimate Aₛᵢ from the appropriate fields (OFDM symbols) of the received estimation frame as described above. Using this SI channel estimate, the station performs SIC on the non-linear SI estimation fields of the received estimation frame. This should lower linear SI components and residual non-linear SI components show up. If the power of these residual SI components exceeds a certain threshold, the station detects this as indication that much non-linear SI occurs. A countermeasure is that the station has to lower its transmit power. In general, the necessary Tx power reduction depends on the hardware characteristic of the power amplifier. By reducing transmit power, the power amplifier operates in a more linear part of its transfer characteristic which reduces non-linear distortion within the output signal.

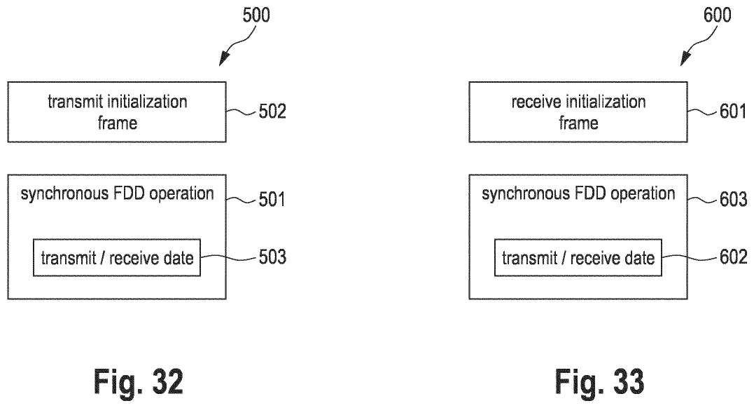

FIG. 32 shows a flowchart of a first communication method 500 according to the present disclosure. In a first step 501 a synchronous frequency division duplex (FDD) operation of two channels is performed, according to which a first channel is primarily to be used for transmission of data from the first communication device to the second communication device and a second channel is primarily to be used for transmission of data from the second communication device to the first communication device. In a second step 502, which is performed before or as part of step 501, an initialization frame configured to trigger synchronous transmission of data by the first communication device and the second communication device is transmitted. In a third step 503, in the synchronous FDD operation, data are transmitted to the second communication device on the first channel and, on the second channel, data are received from the second communication device with pre-compensated third frequency offset between the transmitter circuitry of the first communication device and transmitter circuitry of the second communication device.

FIG. 33 shows a flowchart of a second communication method 600 according to the present disclosure. In a first step 601 an initialization frame is received from the first communication device, the initialization frame triggering synchronous transmission of data by the first communication device and the second communication device in a synchronous frequency division duplex (FDD) operation of two channels, according to which a first channel is primarily to be used for transmission of data from the first communication device to the second communication device and a second channel is primarily to be used for transmission of data from the second communication device to the first communication device. In a second step 602, on the second channel, data are transmitted that are pre-compensated by a third frequency offset between transmitter circuitry of the first communication device and the transmitter circuitry of the second communication device in the synchronous FDD operation (indicated as step 603) to the first communication device and, on the first channel, data are received from the first communication device.

The synchronous variant of bidirectional TXOP can operate together with synchronous FDD which requires synchronicity of the participating STAs in terms of time and/or frequency alignment. Such synchronicity may imply that frame transmissions and receptions are aligned as shown in FIG. 14 which highlight the temporal alignment. Synchronous FDD outlines three phases, namely negotiation or announcement phase, estimation phase and FDD transmission phase. The negotiation or announcement phase generally happens before any FDD communication or estimation phase, potentially as part of a capability exchange. The placement of estimation phase and FDD communication phase within one or more bidirectional TXOPs is elaborated in the following for four different variants that may be applied in different embodiments.

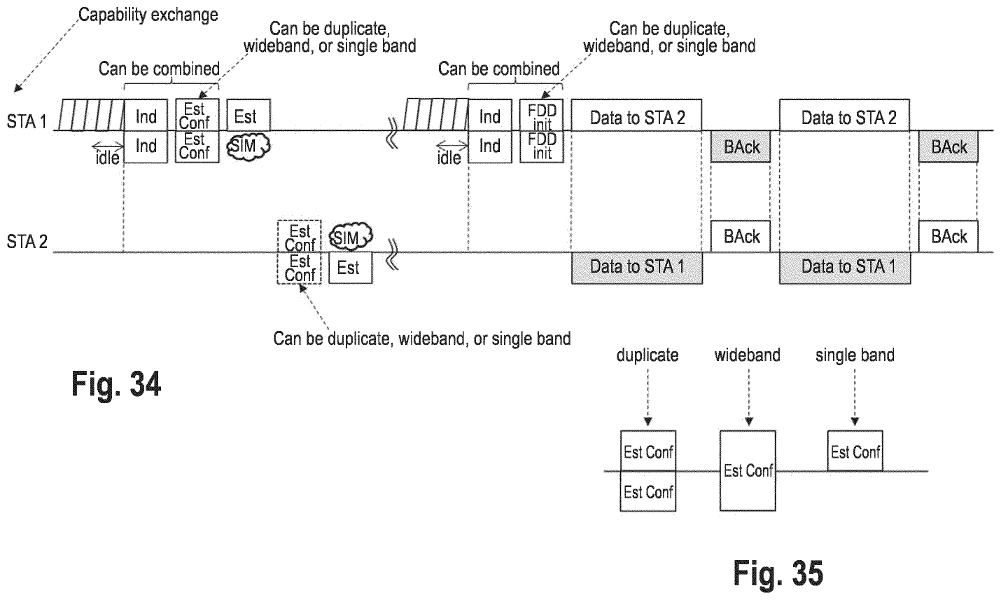

Variant A is depicted in FIG. 34 showing a diagram of an embodiment of a communication scheme using estimation prior to the FDD communication phase. It is assumed that there are two separate bidirectional TXOPs. The first TXOP contains the estimation phase, and the second TXOP contains the actual FDD transmission phase. Since there may be some time in between both bidirectional TXOPs, variant A assumes long term stable self-interference measurement result.

The initiation of the first bidirectional TXOP is done by transmitting the Ind frame in duplicate format. After that, an estimation configuration (est conf) frame is used that may be eithe transmitted in duplicate, wideband or single band format. The estimation configuration defines properties of the subsequent estimation phase for channel 1 and channel 2 respectively. In between both estimation phases, a further estimation configuration may be sent. After the estimation phase, STA 1 has self-interference measurement (SIM) data from channel 1 to channel 2 and STA 2 has self-interference measurement (SIM) data from channel 2 to channel 1. This information is stored and applied for the next bidirectional TXOP, in which the actual data transfer takes place.

The next bidirectional TXOP is established via Ind frame followed by the FDD initialization (FDD init) frame that causes “Data to STA 2” and “Data to STA 1” PPDUs to be transmitted, each followed by BAck. The FDD initialization frame can be sent in duplicate, wide-band or single band format. In the embodiment illustrated in FIG. 34 it is further assumed that the FDD initialization frame causes two subsequent FDD frame exchanges to be elicited before the second bidirectional TXOP ends.

It should be noted that Ind frame and Est conf frame can be combined into one frame, and/or Ind and FDD init frame can be combined into one frame. If the interference measurement result stays valid, more bidirectional TXOPs may follow the estimation phase, i.e. a third bidirectional TXOP can hold another FDD communication phase with the estimation results from the first bidirectional TXOP.

FIG. 35 shows the duplicate, wideband and single band format in more detail. In duplicate format, a frame is duplicated and transmitted on each channel. A receiver that observes just one channel can demodulate this data. In wideband format, a frame is transmitted via large bandwidth covering both channels. This implies that a receiver STA needs to demodulate both channels to demodulate the frame. In single band format, the frame is transmitted only via one channel (i.e. channel 1 or channel 2). A receiver should demodulate this channel in order to properly receive the frame.

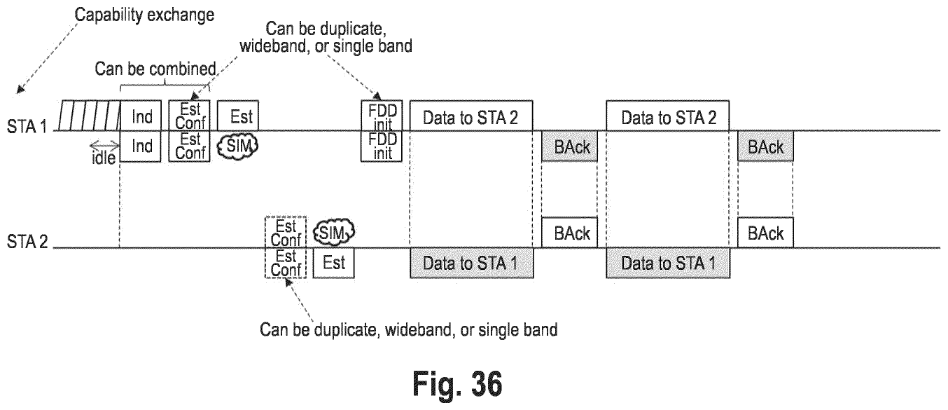

Variant B is depicted in FIG. 36 showing a diagram of an embodiment of a communication scheme using estimation and FDD communication in the same bidirectional TXOP. Variant B corresponds to variant A except that estimation and FDD communication phase take place in the same bidirectional TXOP. Therefore, there is just one duplicated Ind frame at the beginning of the bidirectional TXOP which further holds the Est Conf and FDD init frame at appropriate times.

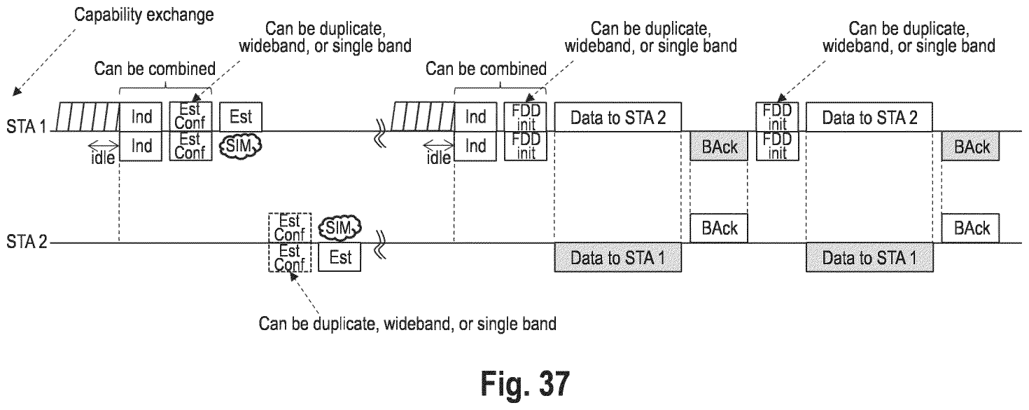

Variant C is depicted in FIG. 37 showing a diagram of an embodiment of a communication scheme using separate FDD init frames for each frame exchange. Variant C corresponds to variant A except that the FDD init frame in the second bidirectional TXOP causes just one FDD frame exchange to take place. Another FDD init frame is needed to cause the second FDD frame exchange (of one or more FDD frames) to be elicited after which the second bidirectional TXOP ends. Generally, there can be one or more frame exchanges in a (bidirectional) TXOP. The bidirectional TXOP defines a temporal length and the main condition is that the frame exchanges fit within this length.

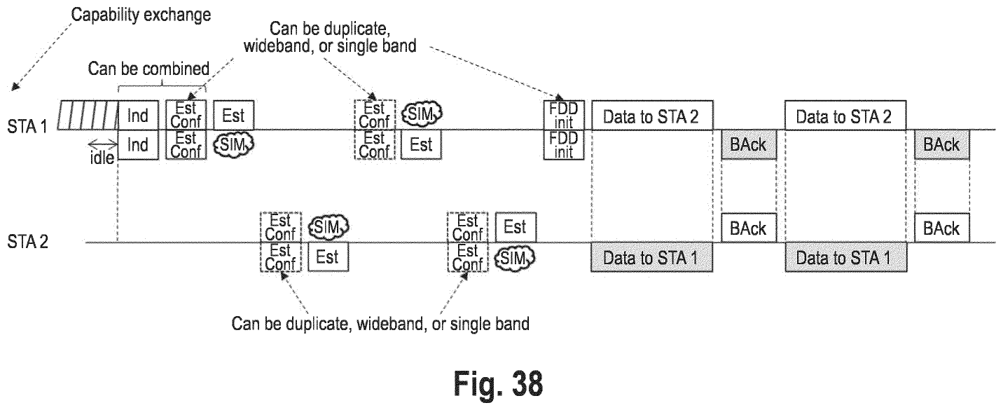

Variant D is depicted in FIG. 38 showing a diagram of an embodiment of a communication scheme with enhanced estimation phase in which reverse direction requires separate SIM. In contrast to variant B, the estimation is not only performed from channel 1 to channel 2 (for STA 1) and from channel 2 to channel 1 (for STA 2), but also from channel 2 to channel 1 (for STA 1) and from channel 1 to channel 2 (for STA 2). In other words, each reverse link is estimated too. Such a measurement is needed in case the BAck is sent at high rate (e.g. high MCS) and therefore a self-interference cancellation or suppression is needed at the receiver STA to decode successfully. Often, the BAck is sent at a low rate and/or the BAck content is less important for FDD type of communication, for which case the estimation of the reverse channel may not always be needed.

In all variants A to D the PHY configuration during the estimation phase should correspond to the PHY configuration of the FDD communication phase as outlined above. Therefore, some sort of identifier may be used in Est Conf and FDD init frames such that each FDD communication phase has a pointer to the fitting self-interference measurement result.

In summary, the present disclosure presents a mechanism to initiate a TXOP between two communication devices operating in unlicensed bands in which data can be bidirectionally exchanged. Each direction of the bidirectional data exchange is separated by different channels as an implementation of FDD. Furthermore, the operation of a bidirectional TXOP in terms of aligned transmissions and receptions are described. Still further, mechanisms for error handling and reconfiguration in case a channel gets at least partially or fully non-usable for data communications are presented. Finally, the operation for synchronous PPDU transmission and reception is described.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriated circuits. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

It follows a first list of further embodiments of the disclosed subject matter:

1. First communication device configured to bidirectionally exchange data with a second communication device, the first communication device comprising circuitry configured to:
initiate a bidirectional transmit opportunity (TXOP) by transmitting, to the second communication device, a TXOP indicator indicating that a wideband TXOP is split into two channels and indicating that a first channel is primarily to be used for transmission of data from the first communication device to the second communication device and a second channel is primarily to be used for transmission of data from the second communication device to the first communication device;
transmit data to the second communication device on the first channel and listen for the reception of data from the second communication device on the second channel.

2. First communication device as defined in embodiment 1, wherein the circuitry is configured to transmit, to the second communication device, a first TXOP indicator on the first channel indicating that the first channel shall primarily be used for transmission of data from the first communication device to the second communication device and a second TXOP indicator on the second channel primarily indicating that the second channel shall primarily be used for transmission of data from the second communication device to the first communication device.

3. First communication device as defined in any one of the preceding embodiments, wherein the circuitry is configured to transmit, to the second communication device, a common wideband TXOP indicator using the first channel and the second channel.

4. First communication device as defined in any one of the preceding embodiments, wherein the first channel and the second channel are sub-channels of a wideband channel or sub-bands of a channel of a wideband channel.

5. First communication device as defined in any one of the preceding embodiments, wherein the first channel and the second channel cover directly adjacent frequency bands or frequency bands separated by a guard band, the guard band having a maximum bandwidth of five times the bandwidth of the first channel or the second channel.

6. First communication device as defined in any one of the preceding embodiments, wherein the first channel includes a primary channel of basic service set (BSS) of which the first communication device and the second communication device are members.

7. First communication device as defined in embodiment 6, wherein the circuitry is configured to perform channel access for accessing the primary channel by counting down a contention window (CW) on at least the primary channel and/or to perform channel access for accessing non-primary channels by listening, on the non-primary channels, for a predetermined period before the channel access on the primary channel and to access the non-primary channels only when the non-primary channel is indicated as idle during the predetermined period.

8. First communication device as defined in any one of the preceding embodiments, wherein the circuitry is configured to transmit a TXOP indicator including one or more of:
time information indicating when the bidirectional TXOP takes effect and data transmission shall start;
duration information indicating the duration of the bidirectional TXOP; and
instruction information indicating that the second communication device shall await further instruction before starting data transmission.

9. First communication device as defined in any one of the preceding embodiments, wherein the circuitry is configured to detect, before initiating the bidirectional TXOP, if the second channel is idle or busy and, if the second channel is idle, initiate bidirectional TXOP.

10. First communication device as defined in any one of the preceding embodiments, wherein the circuitry is configured to
transmit a request-to-send (RTS) frame to the second communication device on the first channel and the second channel,
listen for reception of a clear-to-send (CTS) frame from the second communication device on the first channel and the second channel, and
initiate the bidirectional TXOP only if a CTS frame has been received from the second communication device.

11. First communication device as defined in embodiment 10,
wherein the circuitry is configured to split, if a CTS frame has only been received on one of the first and second channels or on one of multiple sub-bands of one of the first and second channels, the channel or sub-band, on which the CTS has been received, into two sub-channels and use a first sub-channel as first channel and a second sub-channel as second channel in the bidirectional TXOP.

12. First communication device as defined in embodiment 10, wherein the circuitry is configured to transmit a contention free (CF) end frame on a sub-channel on which no CTS has been received from the second communication device.

13. First communication device as defined in any one of the preceding embodiments, wherein the circuitry is configured to transmit a TXOP indicator on the second channel indicating to the second communication device one or more of:
a reverse direction grant (RDG) granting to the second communication device the transmission of frames other than response frames by a setting in an RDG subfield of a data unit;
a contention free poll (CF-Poll) transferring the TXOP ownership to the second communication device for a duration specified within a subfield in CF-Poll subtype frames; and
a single trigger frame enabled TXOP sharing transferring TXOP ownership for the second channel to the second communication device.

14. First communication device as defined in any one of the preceding embodiments, wherein the circuitry is configured to detect, before initiating the bidirectional TXOP, if the second channel is idle or busy and, if the second channel is busy,
wait until the second channel is idle, or
wait until channel access can be achieved, or
start to count down a new a contention window (CW) on the first channel or on the first channel and the second channel.

15. First communication device as defined in any one of the preceding embodiments, wherein the circuitry is configured, if it is detected that one of the first and second channels cannot be used anymore, to
terminate the bidirectional TXOP or
change the use of the other one of the first and second channels into time multiplex use by the first and second communication devices.

16. First communication device as defined in any one of the preceding embodiments, wherein the circuitry is configured to transmit an acknowledgement on the second channel in response to a data unit received from the second communication device on the second channel and/or to listen for the reception of a response frame from the second communication device on the first channel, the acknowledgement including status information indicating if the data unit has been correctly received or not.

17. First communication device as defined in any one of the preceding embodiments, wherein the circuitry is configured to agree or transmit signaling indicating the duration of data units and/or the timing of the transmission of data units by the first and second communication devices.

18. First communication device as defined in any one of the preceding embodiments, wherein the circuitry is configured to obtain a wideband TXOP before transmitting the TXOP indicator.

19. First communication device as defined in any one of the preceding embodiments, wherein the circuitry is configured to split, if a TXOP has only be obtained on one of the first and second channels or on one of multiple sub-bands of one of the first and second channels, the channel or sub-band, on which the TXOP has been obtained, into two sub-channels and use a first sub-channel as first channel and a second sub-channel as second channel in the bidirectional TXOP.

20. First communication device as defined in any one of the preceding embodiments, wherein the circuitry is configured to transmit an acknowledgement on the first channel in response to a data unit received from the second communication device on the second channel and/or to listen for the reception of a response frame from the second communication device on the second channel, the acknowledgement including status information indicating if the data unit has been correctly received or not.

21. Second communication device configured to bidirectionally exchange data with a first communication device, the second communication device comprising circuitry configured to:
receive, from the first communication device, a TXOP indicator to initiate a bidirectional transmit opportunity (TXOP), the TXOP indicator indicating that a wideband TXOP is split into two channels and indicating that a first channel is primarily to be used for transmission of data from the first communication device to the second communication device and a second channel is primarily to be used for transmission of data from the second communication device to the first communication device;
transmit data to the first communication device on the second channel and listen for the reception of data from the first communication device on the first channel.

22. First communication method for bidirectionally exchanging data with a second communication device, the first communication method comprising:
initiating a bidirectional transmit opportunity (TXOP) by transmitting, to the second communication device, a TXOP indicator indicating that a wideband TXOP is split into two channels and indicating that a first channel is primarily to be used for transmission of data from the first communication device to the second communication device and a second channel is primarily to be used for transmission of data from the second communication device to the first communication device;
transmitting data to the second communication device on the first channel and listen for the reception of data from the second communication device on the second channel.

23. Second communication method for bidirectionally exchanging data with a first communication device, the second communication method comprising:
receiving, from the first communication device, a TXOP indicator to initiate a bidirectional transmit opportunity (TXOP), the TXOP indicator indicating that a wide-band TXOP is split into two channels and indicating that a first channel is primarily to be used for transmission of data from the first communication device to the second communication device and a second channel is primarily to be used for transmission of data from the second communication device to the first communication device;
transmitting data to the first communication device on the second channel and listen for the reception of data from the first communication device on the first channel.

24. A non-transitory computer-readable recording medium that stores therein a computer program product, which, when executed by a processor, causes the method according to embodiment 22 or 23 to be performed.

25. A computer program comprising program code means for causing a computer to perform the steps of said method according to embodiment 22 or 23 when said computer program is carried out on a computer.

It follows a second first list of further embodiments of the disclosed subject matter which may be combined with one or more of the embodiments of the first list given above:

A1. First communication device configured to bidirectionally exchange data with a second communication device, the first communication device comprising circuitry including transmitter circuitry and receiver circuitry, the circuitry being configured to:
perform a synchronous frequency division duplex (FDD) operation of two channels, according to which a first channel is primarily to be used for transmission of data from the first communication device to the second communication device and a second channel is primarily to be used for transmission of data from the second communication device to the first communication device, transmit an initialization frame configured to trigger synchronous transmission of data by the first communication device and the second communication device, and transmit, in the synchronous FDD operation, data to the second communication device on the first channel and receive, on the second channel, data from the second communication device with pre-compensated third frequency offset between the transmitter circuitry of the first communication device and transmitter circuitry of the second communication device.

A2. First communication device as defined in embodiment A1, wherein the circuitry is configured to pre-compensate a first frequency offset between its transmitter circuitry and its receiver circuitry and to transmit the initialization frame and/or data with pre-compensated first frequency offset in the synchronous FDD operation.

A3. First communication device as defined in embodiment A1 or A2, wherein the circuitry is configured to
transmit an estimation frame on the first channel and
determine, based on the transmission of the estimation frame, a self-interference channel estimate and/or a first frequency offset between its transmitter circuitry and its receiver circuitry.

A4. First communication device as defined in any one of the preceding embodiments, wherein the first channel and the second channel cover directly adjacent frequency bands or frequency bands separated by a guard band, the guard band having a maximum bandwidth of five times the bandwidth of the first channel or the second channel.

A5. First communication device as defined in embodiment A3, wherein the circuitry is configured to determine the self-interference channel estimate in the frequency domain based on the estimation frame by determining a complex value for each subcarrier by dividing, per subcarrier index, the received symbol on the second channel by the transmitted symbol of the first channel. and/or to determine the self-interference channel estimate in the time domain by performing an inverse Fourier transform on the frequency-domain self-interference channel estimate.

A6. First communication device as defined in embodiment A3 or A5, wherein the circuitry is configured to cancel self-interference by subtracting the determined self-interference channel estimate convolved in time domain or multiplied in frequency domain by a current transmit signal on the first channel from a signal received from the second communication device on the second channel.

A7. First communication device as defined in embodiment A6, wherein the circuitry is configured to cancel self-interference only if a PHY configuration and/or PHY parameters used when transmitting the estimation frame is the same as used for transmitting a current transmit signal on the first channel.

A8. First communication device as defined in embodiment A6 or A7, wherein the circuitry is configured to obtain the current transmit signal internally via an interface between its transmitter circuitry and its receiver circuitry or wirelessly by its receiver circuitry that is not only receiving the bandwidth of the second channel but also the first channel.

A9. First communication device as defined in embodiment A3 or A5 to A8, wherein the circuitry is configured to transmit the estimation frame and the initialization frame combined into a common frame.

A10. First communication device as defined in embodiment A3 or A5 to A9, wherein the circuitry is configured to:
determine, based on the transmission of the estimation frame, if there is non-linear self-interference,
transmit, if there is non-linear self-interference, a second estimation frame with reduced transmit power,
determine, based on the transmission of the second estimation frame, if there is still non-linear self-interference, and
initiate the synchronous FDD operation if there is no more non-linear self-interference or if the non-linear self-interference does not exceed a non-linear self-interference limit.

A11. First communication device as defined in embodiment A3 or A5 to A10, wherein the estimation frame comprises one or more of:
one or more sequences allowing frequency offset estimation and/or timing offset estimation;
at least one OFDM symbol covering all data subcarriers;
at least one sequence allowing the estimation of the strength of non-linear self-interference components;
a non-empty data field containing payload from higher layers; and
a field for frequency offset estimation allowing estimation of a first frequency offset between its transmitter circuitry and its receiver circuitry and/or estimation of the third frequency offset between the transmitters of the first and second communication devices.

A12. First communication device as defined in embodiment A3 or A5 to A11, wherein the circuitry is configured to:
transmit a null data packet (NDP) announcement frame indicating a configuration to be used for a subsequent self-interference channel estimation by the first and/or second communication devices and
transmit an NDP as estimation frame.

A13. First communication device as defined in any one of the preceding embodiments, wherein the circuitry is configured to transmit an initialization frame including one or more of:
FDD configuration information for use in data transmission during the synchronous FDD operation, the FDD configuration information including one or more of the channels, subcarrier spacing and guard interval length used by the first and second communication devices during the synchronous FDD operation;
timing information indicating the length of a data unit and/or the timing of the transmission of data units by the first and second communication devices and/or the length of a time gap between subsequent data units and/or response frames;
channel estimation sequences allowing frequency offset estimation and/or timing offset estimation by the second communication device; and start information indicating that the synchronous FDD operation can begin after reception of the initialization frame.

A14. First communication device as defined in any one of the preceding embodiments, wherein the circuitry is configured to transmit an initialization frame before the transmission of a first data unit or before the transmission of each data unit.

A15. First communication device as defined in embodiment A10, wherein the circuitry is configured to transmit an estimation announcement frame indicating the presence of a subsequent self-interference channel estimation and/or a configuration to be used for a subsequent self-interference channel estimation by the first and/or second communication devices.

A16. First communication device as defined in any one of the preceding embodiments, wherein the circuitry is configured to:
transmit, if self-interference above a limit is detected during the synchronous FDD operation, a notification to the second communication device indication that self-interference will be estimated again,
transmit a new estimation frame on the first channel,
determine the new self-interference channel estimate based on the transmission of the new estimation frame, and
continue with the previous synchronous FDD or initiate a new synchronous FDD operation to transmit data and compensate self-interference with the new self-interference channel estimate.

A17. First communication device as defined in any one of the preceding embodiments, wherein the circuitry is configured to obtain a bidirectional transmit opportunity (TXOP) for the synchronous FDD operation.

A18. First communication device as defined in embodiment A17, wherein the circuitry is configured to negotiate, before obtaining the bidirectional TXOP for the synchronous FDD operation, with the second communication device by transmitting and receiving negotiation frames in time-division duplex (TDD) operation, a negotiation frame including one or more of:
information which FDD configurations the respective communication device is capable of;
information which bandwidths the respective communication device is capable of using for the synchronous FDD operation;
information whether the use of a combined estimation frame and initialization frame is supported; and information which maximum FDD frame length the respective communication device is capable of using for the synchronous FDD operation.

A19. First communication device as defined in any one of the preceding embodiments, wherein the circuitry is configured to transmit data during the synchronous FDD operation in the form of data units fulfilling one or more of the following conditions:
the data units comprise channel estimation sequences
the data units have the same length as data units received from the second communication device;
the data units use a FDD configuration declared in the initialization frame;
the transmit power used for transmitting data units is the same as the transmit power used during the determination of a self-interference channel estimate; and the data units comprise information if another data unit will subsequently be transmitted.

A20. First communication device as defined in any one of the preceding embodiments, wherein the circuitry is configured to initiate the bidirectional TXOP by transmitting, to the second communication device, a TXOP indicator indicating that a wideband TXOP is split into two channels and indicating that the first channel is primarily to be used for transmission of data from the first communication device to the second communication device and the second channel is primarily to be used for transmission of data from the second communication device to the first communication device.

A21. Second communication device configured to bidirectionally exchange data with a first communication device, the second communication device comprising circuitry including transmitter circuitry and receiver circuitry, the circuitry being configured to:
receive an initialization frame from the first communication device, the initialization frame triggering synchronous transmission of data by the first communication device and the second communication device in a synchronous frequency division duplex (FDD) operation of two channels, according to which a first channel is primarily to be used for transmission of data from the first communication device to the second communication device and a second channel is primarily to be used for transmission of data from the second communication device to the first communication device, and
transmit, on the second channel, data that are pre-compensated by a third frequency offset between transmitter circuitry of the first communication device and the transmitter circuitry of the second communication device in the synchronous FDD operation to the first communication device and receive, on the first channel, data from the first communication device.

A22. Second communication device as defined in embodiment A21, wherein the circuitry is configured to determine, using the initialization frame or an estimation frame received from the first communication device, the third frequency offset between transmitter circuitry of the first communication device and the receiver circuitry of the second communication device.

A23. Second communication device as defined in any one of the embodiments A21 to A22, wherein the circuitry is configured to transmit data with pre-compensated second frequency offset and/or pre-compensated third frequency offset in the synchronous FDD operation.

A24. Second communication device as defined in any one of the embodiments A21 to A23, wherein the circuitry is configured to participate in self-interference estimation frame exchange by transmitting, after an estimation announcement, an estimation frame to determine a self-interference channel estimate on the first channel.

A25. Second communication device as defined in any one of the embodiments A21 to A24, wherein the circuitry is configured to pre-compensate a second frequency offset between its transmitter circuitry and its receiver circuitry.

A26. First communication method of a first communication device configured to bidirectionally exchange data with a second communication device, the first communication device comprising circuitry including transmitter circuitry and receiver circuitry, the method comprising:
performing a synchronous frequency division duplex (FDD) operation of two channels, according to which a first channel is primarily to be used for transmission of data from the first communication device to the second communication device and a second channel is primarily to be used for transmission of data from the second communication device to the first communication device,
transmitting an initialization frame configured to trigger synchronous transmission of data by the first communication device and the second communication device, and
transmitting, in the synchronous FDD operation, data to the second communication device on the first channel and receive, on the second channel, data from the second communication device with pre-compensated third frequency offset between the transmitter circuitry of the first communication device and transmitter circuitry of the second communication device.

A27. Second communication method of a second communication device configured to bidirectionally exchange data with a first communication device, the second communication device comprising circuitry including transmitter circuitry and receiver circuitry, the method comprising:
receiving an initialization frame from the first communication device, the initialization frame triggering synchronous transmission of data by the first communication device and the second communication device in a synchronous frequency division duplex (FDD) operation of two channels, according to which a first channel is primarily to be used for transmission of data from the first communication device to the second communication device and a second channel is primarily to be used for transmission of data from the second communication device to the first communication device, and
transmitting, on the second channel, data that are pre-compensated by a third frequency offset between transmitter circuitry of the first communication device and the transmitter circuitry of the second communication device in the synchronous FDD operation to the first communication device and receive, on the first channel, data from the first communication device.

A28. A non-transitory computer-readable recording medium that stores therein a computer program product, which, when executed by a processor, causes the method according to embodiment A26 or A27 to be performed.

A29. A computer program comprising program code means for causing a computer to perform the steps of said method according to embodiment A26 or A27 when said computer program is carried out on a computer.

1. First communication device configured to bidirectionally exchange data with a second communication device, the first communication device comprising circuitry configured to:
initiate a bidirectional transmit opportunity (TXOP) by transmitting, to the second communication device, a TXOP indicator indicating that a wideband TXOP is split into two channels and indicating that a first channel is primarily to be used for transmission of data from the first communication device to the second communication device and a second channel is primarily to be used for transmission of data from the second communication device to the first communication device;
transmit data to the second communication device on the first channel and listen for the reception of data from the second communication device on the second channel.

2. First communication device as claimed in claim 1,
wherein the circuitry is configured to transmit, to the second communication device, a first TXOP indicator on the first channel indicating that the first channel shall primarily be used for transmission of data from the first communication device to the second communication device and a second TXOP indicator on the second channel primarily indicating that the second channel shall primarily be used for transmission of data from the second communication device to the first communication device.

3. First communication device as claimed in claim 1,
wherein the circuitry is configured to transmit, to the second communication device, a common wideband TXOP indicator using the first channel and the second channel.

4. First communication device as claimed in claim 1,
wherein the first channel and the second channel are sub-channels of a wideband channel or sub-bands of a channel of a wideband channel or
wherein the first channel and the second channel cover directly adjacent frequency bands or frequency bands separated by a guard band, the guard band having a maximum bandwidth of five times the bandwidth of the first channel or the second channel.

5. First communication device as claimed in claim 1,
wherein the first channel includes a primary channel of basic service set (BSS) of which the first communication device and the second communication device are members.

6. First communication device as claimed in claim 5,
wherein the circuitry is configured to perform channel access for accessing the primary channel by counting down a contention window (CW) on at least the primary channel and/or to perform channel access for accessing non-primary channels by listening, on the non-primary channels, for a predetermined period before the channel access on the primary channel and to access the non-primary channels only when the non-primary channel is indicated as idle during the predetermined period.

7. First communication device as claimed in claim 1,
wherein the circuitry is configured to transmit a TXOP indicator including one or more of:
time information indicating when the bidirectional TXOP takes effect and data transmission shall start;
duration information indicating the duration of the bidirectional TXOP; and
instruction information indicating that the second communication device shall await further instruction before starting data transmission.

8. First communication device as claimed in claim 1,
wherein the circuitry is configured to detect, before initiating the bidirectional TXOP, if the second channel is idle or busy and, if the second channel is idle, initiate bidirectional TXOP.

9. First communication device as claimed in claim 1,
wherein the circuitry is configured to
transmit a request-to-send (RTS) frame to the second communication device on the first channel and the second channel,
listen for reception of a clear-to-send (CTS) frame from the second communication device on the first channel and the second channel, and
initiate the bidirectional TXOP only if a CTS frame has been received from the second communication device.

10. First communication device as claimed in claim 9,
wherein the circuitry is configured to split, if a CTS frame has only been received on one of the first and second channels or on one of multiple sub-bands of one of the first and second channels, the channel or sub-band, on which the CTS has been received, into two sub-channels and use a first sub-channel as first channel and a second sub-channel as second channel in the bidirectional TXOP and/or to transmit a contention free (CF) end frame on a sub-channel on which no CTS has been received from the second communication device.

11. First communication device as claimed in claim 1,
wherein the circuitry is configured to transmit a TXOP indicator on the second channel indicating to the second communication device one or more of:
a reverse direction grant (RDG) granting to the second communication device the transmission of frames other than response frames by a setting in an RDG subfield of a data unit;
a contention free poll (CF-Poll) transferring the TXOP ownership to the second communication device for a duration specified within a subfield in CF-Poll subtype frames; and
a single trigger frame enabled TXOP sharing transferring TXOP ownership for the second channel to the second communication device.

12. First communication device as claimed in claim 1,
wherein the circuitry is configured to detect, before initiating the bidirectional TXOP, if the second channel is idle or busy and,
if the second channel is busy,
wait until the second channel is idle, or
wait until channel access can be achieved, or
start to count down a new a contention window (CW) on the first channel or on the first channel and the second channel.

13. First communication device as claimed in claim 1,
wherein the circuitry is configured, if it is detected that one of the first and second channels cannot be used anymore, to
terminate the bidirectional TXOP or
change the use of the other one of the first and second channels into time multiplex use by the first and second communication devices.

14. First communication device as claimed in claim 1,
wherein the circuitry is configured to transmit an acknowledgement on the second channel in response to a data unit received from the second communication device on the second channel and/or to listen for the reception of a response frame from the second communication device on the first channel, the acknowledgement including status information indicating if the data unit has been correctly received or not.

15. First communication device as claimed in claim 1,
wherein the circuitry is configured to agree or transmit signaling indicating the duration of data units and/or the timing of the transmission of data units by the first and second communication devices.

16. First communication device as claimed in claim 1,
wherein the circuitry is configured to obtain a wideband TXOP before transmitting the TXOP indicator and/or to split, if a TXOP has only be obtained on one of the first and second channels or on one of multiple sub-bands of one of the first and second channels, the channel or sub-band, on which the TXOP has been obtained, into two sub-channels and use a first sub-channel as first channel and a second sub-channel as second channel in the bidirectional TXOP.

17. Second communication device configured to bidirectionally exchange data with a first communication device, the second communication device comprising circuitry configured to:
receive, from the first communication device, a TXOP indicator to initiate a bidirectional transmit opportunity (TXOP), the TXOP indicator indicating that a wideband TXOP is split into two channels and indicating that a first channel is primarily to be used for transmission of data from the first communication device to the second communication device and a second channel is primarily to be used for transmission of data from the second communication device to the first communication device;
transmit data to the first communication device on the second channel and listen for the reception of data from the first communication device on the first channel.

18. First communication method for bidirectionally exchanging data with a second communication device, the first communication method comprising:
initiating a bidirectional transmit opportunity (TXOP) by transmitting, to the second communication device, a TXOP indicator indicating that a wideband TXOP is split into two channels and indicating that a first channel is primarily to be used for transmission of data from the first communication device to the second communication device and a second channel is primarily to be used for transmission of data from the second communication device to the first communication device;
transmitting data to the second communication device on the first channel and listen for the reception of data from the second communication device on the second channel.

19. Second communication method for bidirectionally exchanging data with a first communication device, the second communication method comprising:
receiving, from the first communication device, a TXOP indicator to initiate a bidirectional transmit opportunity (TXOP), the TXOP indicator indicating that a wide-band TXOP is split into two channels and indicating that a first channel is primarily to be used for transmission of data from the first communication device to the second communication device and a second channel is primarily to be used for transmission of data from the second communication device to the first communication device;
transmitting data to the first communication device on the second channel and listen for the reception of data from the first communication device on the first channel.

20. A non-transitory computer-readable recording medium that stores therein a computer program product, which, when executed by a processor, causes the method according to claim 18 or 19 to be performed.
